(19) United States
(12) Patent Application Publication
(10) Pub. No.: US 2026/0173046 A1
(43) Pub. Date: Jun. 18, 2026

(54) DYNAMIC CHANGE OF WAVEFORMS ASSOCIATED WITH WIRELESS COMMUNICATION

(71) Applicant: InterDigital Patent Holdings, Inc., Wilmington, DE (US)

(72) Inventors: Young Woo Kwak, Woodbury, NY (US); Moon-il Lee, Melville, NY (US); Paul Marinier, Brossard (CA); Nazli Khan Beigi, Longueuil (CA)

(73) Assignee: InterDigital Patent Holdings, Inc., Wilmington, DE (US)

(21) Appl. No.: 18/707,389

(22) PCT Filed: Nov. 2, 2022
(86) PCT No.: PCT/US2022/048726

§ 371 Date: May 3, 2024

Related U.S. Application Data
(60) Provisional application No. 63/275,813, filed on Nov. 4, 2021.

(51) Int. Cl. H04W 72/0453; H04L 27/26; H04W 72/1273

(52) U.S. Cl. CPC H04W 72/0453; H04L 27/2601; H04W 72/1273

(57) ABSTRACT

Systems, methods, and instrumentalities are described herein for dynamic changes of waveforms for wireless commu-2023/081225 nication. Examples of hybrid initial access by using single carrier waveforms and CP-OFDM waveforms are provided herein. Initial access related signals for both DFT-S-OFDM waveforms and CP-OFDM waveforms may be transmitted. The transmission of initial access related signals for both DFT-S-OFDM and CP-OFDM waveforms may be based on one or more of: carrier frequency, frequency bands, subcarrier spacing, etc. The transmission of initial access related signals for both DFT-S-OFDM and CP-OFDM waveforms may include frequency domain multiplexing of PSS/SSS to reduce time domain resource overhead.

### CROSS-REFERENCE TO RELATED APPLICATIONS

This application claims the benefit of Provisional U.S. patent application Ser. No. 63/275,813, filed Nov. 4, 2021, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for dynamic changes of waveforms associated with wireless communication.

A wireless transmit/receive unit (WTRU) may receive slot format configuration information (e.g., a slot format indication) for multiple waveform types. The slot format configuration information (e.g., the slot format indication) may indicate information for multiple slots. For example, the slot format configuration information (e.g., the slot format indication) may indicate, for a given slot, whether a particular waveform (e.g., one of a first or second waveform) is indicated for the slot or whether the slot is indicated as flexible (e.g., if the slot is indicated as flexible, a waveform type used for the slot may not be fixed and may be chosen, for example based on conditions such as those described herein. As an illustration, using example waveform types of cyclic prefix—orthogonal frequency domain multiplexing (CP-OFDM) and discrete fourier transform-spread-orthogonal frequency domain multiplexing (DFT-s-OFDM), the slot format configuration information (e.g., a slot format indication) may indicate, for each slot in a number of slots, whether the slot is indicated as being flexible, associated with CP-OFDM, or associated with DFT-s-OFDM. The slot format configuration information (e.g., the slot format indication) may be based on (e.g., received via) one or more of the following: a radio resource control (RRC) configuration; a medium access control element control element (MAC CE); or downlink control information (DCI) (e.g., a WTRU specific DCI and/or a group DCI).

Slot format configuration information (e.g., a slot format indication) may be received by a WTRU. The slot format configuration information may indicate information for multiple slots. For example, the slot format configuration information may indicate whether a first slot has a first waveform type associated with the first slot or is flexible and whether a second slot has a second waveform type associated with the second slot or is flexible. The WTRU may receive a physical downlink control channel (PDCCH) transmission in the first slot. The PDCCH transmission may be received via a waveform of a prioritized waveform type if the first slot is indicated in the slot format configuration information as flexible or via a waveform of the first waveform type if the first waveform type is indicated in the slot format configuration information as being associated with the first slot. The PDCCH transmission may include DCI that schedules a physical downlink shared channel (PDSCH) transmission and indicates an indicated waveform type associated with reception of the PDSCH transmission. The WTRU may receive the PDSCH transmission in the second slot. The PDSCH transmission may be received via a waveform of the indicated waveform type if the second slot is flexible or via a waveform of the second waveform type if the second waveform type is indicated in the slot format configuration information as being associated with the second slot.

The second waveform type may be indicated in the slot format configuration information as being associated with the second slot. In examples, the waveform of second waveform type associated with the second slot may be indicated in the slot format configuration information to be a DFT-s-OFDM waveform. In the case where the second slot is indicated in the slot format configuration information to be a DFT-s-OFDM waveform, the second slot may carry at least one of: an initial access related signal, a configurable control resource set (CORESET)/synchronization signal (SS), or a reference signal for the DFT-s-OFDM waveform. Based on the second waveform type being indicated in the slot format configuration information as being associated with the second slot and the waveform of the second waveform type associated with the second slot being indicated to be a DFT-s-OFDM waveform, the WTRU may apply an inverse discrete fourier transform (IDFT) before decoding the PDSCH transmission.

In examples, the waveform of the second waveform type associated with the second slot may be indicated in the slot format configuration information to be a CP-OFDM waveform. In the case where the second slot is indicated in the slot format configuration information to be a CP-OFDM waveform, the second slot may carry at least one of: an initial access related signal, a configurable control resource set (CORESET)/synchronization signal (SS), or a reference signal for the CP-OFDM waveform. Based on the second waveform type being indicated in the slot format configuration information as being associated with the second slot and the waveform of the second waveform type associated with the second slot being indicated to be a CP-OFDM waveform, the WTRU may be configured to decode the PDSCH transmission without applying an inverse discrete fourier transform (IDFT).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates example available frequencies between 52.6 GHz and 71 GHz.

FIG. 3 illustrates example available frequencies between 71 GHz and 100 GHz.

FIG. 4 illustrates an example of waveform type indication in CORESET/search space configuration table.

FIGS. 5A-5C illustrate examples of different CORESET/search multiplexing patterns.

FIGS. 6A-6B illustrate examples of different CORESET/search space structure.

FIGS. 7-8 illustrate slot format configuration information (e.g., a slot format indication) for multiple waveforms.

### DETAILED DESCRIPTION

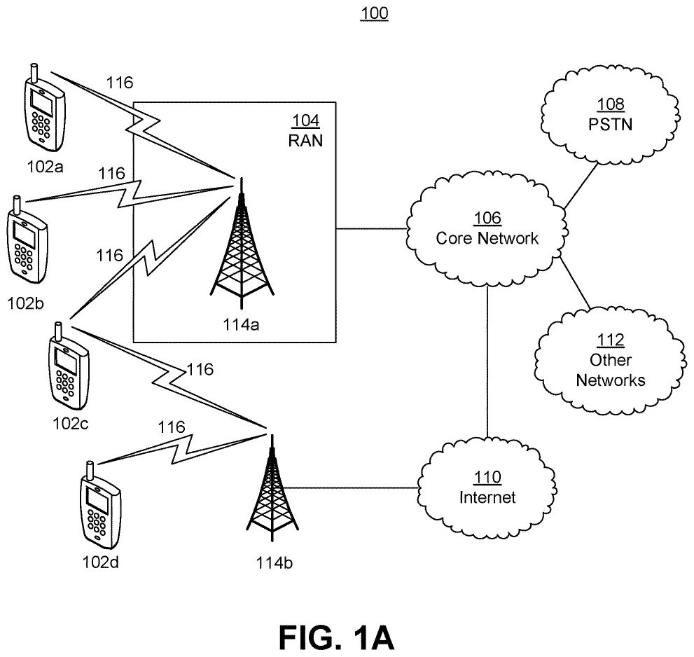

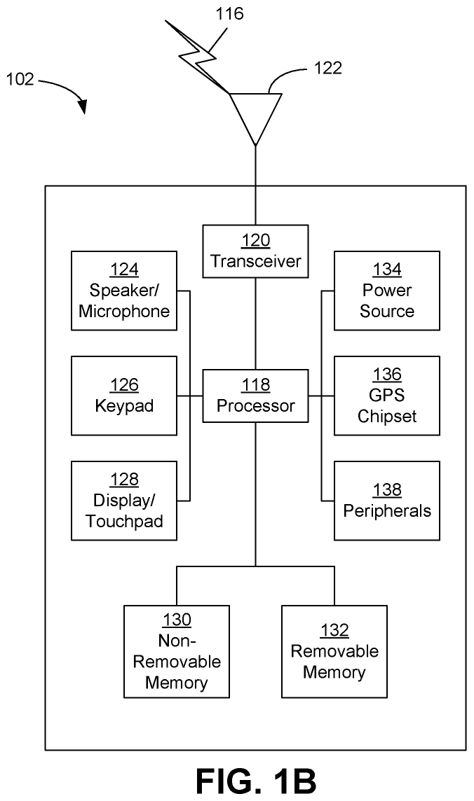

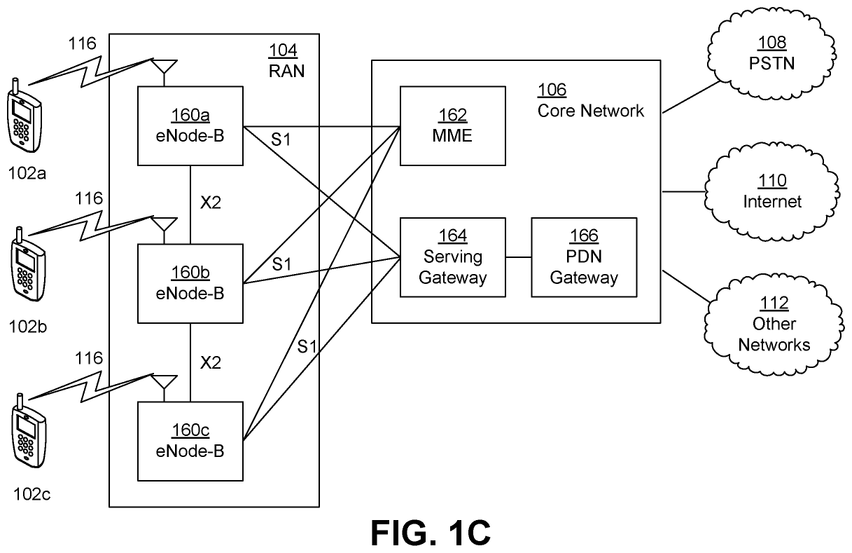

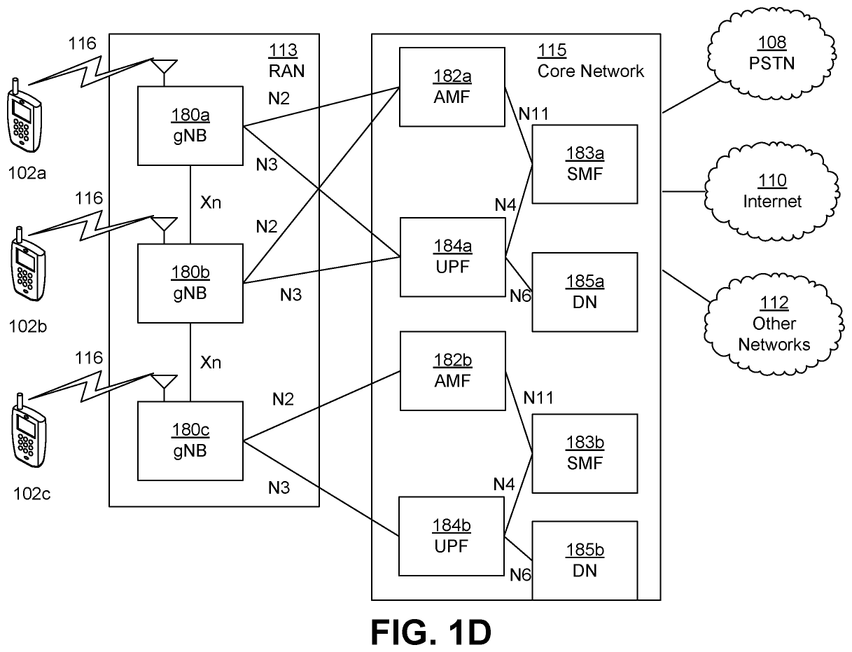

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108.

In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for dynamic changes of waveforms associated with wireless communication.

A wireless transmit/receive unit (WTRU) may receive slot format configuration information (e.g., a slot format indication) for multiple waveform types. The slot format configuration information (e.g., the slot format indication) may indicate information for multiple slots. For example, the slot format configuration information (e.g., the slot format indication) may indicate, for a given slot, whether a particular waveform (e.g., one of a first or second waveform) is indicated for the slot or whether the slot is indicated as flexible (e.g., if the slot is indicated as flexible, a waveform type used for the slot may not be fixed and may be chosen, for example based on conditions such as those described herein. As an illustration, using example waveform types of cyclic prefix-orthogonal frequency domain multiplexing (CP-OFDM) and discrete fourier transform-spread-orthogonal frequency domain multiplexing (DFT-s-OFDM), the slot format configuration information (e.g., a slot format indication) may indicate, for each slot in a number of slots, whether the slot is indicated as being flexible, associated with CP-OFDM, or associated with DFT-s-OFDM. The slot format configuration information (e.g., the slot format indication) may be based on (e.g., received via) one or more of the following: a radio resource control (RRC) configuration; a medium access control element control element (MAC CE); or downlink control information (DCI) (e.g., a WTRU specific DCI and/or a group DCI).

Slot format configuration information (e.g., a slot format indication) may be received by a WTRU. The slot format configuration information may indicate information for multiple slots. For example, the slot format configuration information may indicate whether a first slot has a first waveform type associated with the first slot or is flexible and whether a second slot has a second waveform type associated with the second slot or is flexible. The WTRU may receive a physical downlink control channel (PDCCH) transmission in the first slot. The PDCCH transmission may be received via a waveform of a prioritized waveform type if the first slot is indicated in the slot format configuration information as flexible or via a waveform of the first waveform type if the first waveform type is indicated in the slot format configuration information as being associated with the first slot. The PDCCH transmission may include DCI that schedules a physical downlink shared channel (PDSCH) transmission and indicates an indicated waveform type associated with reception of the PDSCH transmission. The WTRU may receive the PDSCH transmission in the second slot. The PDSCH transmission may be received via a waveform of the indicated waveform type if the second slot is flexible or via a waveform of the second waveform type if the second waveform type is indicated in the slot format configuration information as being associated with the second slot.

The second waveform type may be indicated in the slot format configuration information as being associated with the second slot. In examples, the waveform of second waveform type associated with the second slot may be indicated in the slot format configuration information to be a DFT-s-OFDM waveform. In the case where the second slot is indicated in the slot format configuration information to be a DFT-s-OFDM waveform, the second slot may carry at least one of: an initial access related signal, a configurable control resource set (CORESET)/synchronization signal (SS), or a reference signal for the DFT-s-OFDM waveform. Based on the second waveform type being indicated in the slot format configuration information as being associated with the second slot and the waveform of the second waveform type associated with the second slot being indicated to be a DFT-s-OFDM waveform, the WTRU may apply an inverse discrete fourier transform (IDFT) before decoding the PDSCH transmission.

In examples, the waveform of the second waveform type associated with the second slot may be indicated in the slot format configuration information to be a CP-OFDM waveform. In the case where the second slot is indicated in the slot format configuration information to be a CP-OFDM waveform, the second slot may carry at least one of: an initial access related signal, a configurable control resource set (CORESET)/synchronization signal (SS), or a reference signal for the CP-OFDM waveform. Based on the second waveform type being indicated in the slot format configuration information as being associated with the second slot and the waveform of the second waveform type associated with the second slot being indicated to be a CP-OFDM waveform, the WTRU may be configured to decode the PDSCH transmission without applying an inverse discrete fourier transform (IDFT).

Transmission(s) being received via a waveform type may be equivalent to transmission(s) being received via a waveform of a waveform type. Waveform type(s) being associated with slot(s) may be equivalent to waveform(s) of waveform type(s) being associated with slot(s). A WTRU using a waveform type may be equivalent to a WTRU using a waveform of a waveform type.

Examples of hybrid initial access by using single carrier waveforms and a CP-OFDM waveform are provided herein. Initial access related signals for a DFT-S-OFDM waveform and a CP-OFDM waveform may be transmitted. The initial access related signals may include one or more of: a primary synchorization signal (PSS) for hybrid operation, a PRACH resource for waveform determination, a secondary synchronization signal (SSS) with a DFT-S-OFDM waveform and m-sequence for DFT-S-OFDM based initial access waveform, a PBCH with a DFT-S-OFDM waveform, a CORESET structure including CORESET #0, or a MSG3 in a DFT-S-OFDM waveform.

The PSS for hybrid operation may be a PSS based on a Zadoff-Chu signal. If the WTRU blindly detects a Zadoff-Chu signal based PSS, the WTRU may determine a DFT-S-OFDM based initial access waveform. The PSS for hybrid operation may be a waveform type indication based on one or more of a PSS index (e.g., preamble), a synchronization signal block (SSB) pattern (e.g., time gap between PSS and SSS), or a sync raster. The WTRU may determine the waveform for initial access based on the detected PSS index and/or sync raster. The PSS for hybrid operation may be a WTRU prioritization on a CP-OFDM based initial access waveform operation. The WTRU may include low implementation WTRUs for a CP-OFDM waveform or advanced WTRUs for a CP-OFDM waveform and a DFT-S-OFDM waveform. The PSS for hybrid operation may include frequency resources (e.g., other frequency resources) to utilize.

A physical random access channel (PRACH) resource for waveform determination may be determined by a WTRU based on a selection of the PRACH resource. The WTRU determination may be reported. For the second SSS with a DFT-S-OFDM waveform and m-sequence for a DFT-S-OFDM based initial access waveform, based on the determined initial access waveform, the WTRU may apply an IDFT for SSS decoding. For the PBCH with a DFT-S-OFDM waveform, based on the determined initial access waveform, the WTRU may apply an IDFT for SSS decoding. If the PSS and SSS are common for both a CP-OFDM waveform and a DFT-S-OFDM waveform, a master information block (MIB) may indicate a waveform type for initial access. For the CORESET structure including CORESET #0, based on the determined initial access waveform, the WTRU may detect (e.g., blindly detect) a PDCCH based on different CORESET structures. For a DFT-S-OFDM waveform, PDCCH data symbols and demodulation reference signal (DMRS) symbols may be independent for a new resource element group (REG) design. For MSG3 in a DFT-S-OFDM waveform, whether to use a CP-OFDM waveform or a DFT-S-OFDM waveform may be configurable by an RRC configuration. If the WTRU determines a DFT-S-OFDM based initial access waveform, the WTRU may (e.g., may always) use DFT-S-OFDM MSG3.

The transmission of initial access related signals for both a DFT-S-OFDM waveform and a CP-OFDM waveform may be based on one or more of: carrier frequency, frequency bands, subcarrier spacing, etc. The transmission of initial access related signals for both a DFT-S-OFDM waveform and a CP-OFDM waveform may include frequency domain multiplexing of PSS/SSS to reduce time domain resource overhead. The transmission of initial access related signals for both a DFT-S-OFDM waveform and a CP-OFDM waveform may include multiple transmitters to maintain a same amount of back-off (e.g., one power amplifier (PA) for SSB, another PA for PDSCH).

Examples of slot level dynamic switching between different waveforms are provided herein. Slot level dynamic switching may include slot format configuration/indication for waveform types (e.g., CP-OFDM, DFT-S-OFDM or flexible). The slot formation configuration information (e.g., the slot format indication) may indicate, for a given slot, whether a particular waveform (e.g., one of a first or second waveform) is indicated for the slot of whether the slot is flexible. The slot formation configuration information may indicate a first waveform type associated with a first slot and a second waveform type associated with a second slot. In examples, the first waveform type may be a CP-OFDM waveform associated with the first slot (e.g., the CP-OFDM slot). The first slot (e.g., the CP-OFDM slot) may include initial access related signals, CORESET/SS, and reference signals (RSs) for a CP-OFDM waveform. In examples, the first waveform type may be a DFT-s-OFDM waveform associated with the first slot (e.g., the DFT-S-OFDM slot). The first slot (e.g., the DFT-s-OFDM slot) may include initial access related signals, CORESET/SS, and RSs for a DFT-S-OFDM waveform. If the slot is flexible, the slot may be without signals for initial access and RSs, so the WTRU may determine slot format based on the dynamic indication (e.g., symbol level dynamic switching). Waveform determination may be based on the indicated slot format. Application of waveform specific designs may be based on the determined waveform.

Examples of symbol level dynamic switching between different waveforms (e.g., DFT-S-OFDM and CP-OFDM) are provided herein. A WTRU may determine a waveform for PDSCH reception based on one or more of following: a transmission configuration index (TCI) state (e.g., an explicit configuration in a TCI state) (e.g., SC-waveform for wider beam to achieve better coverage and CP-OFDM for narrow beam); or PDSCH scheduling (e.g., modulation and coding scheme (MCS), frequency domain resource allocation (FDRA) (e.g., scheduled resource blocks (RBs), time domain resource allocation (TDRA) (e.g., explicit configuration in TDRA)). Examples of BWP level dynamic switching between different waveforms are provided herein. The waveform may be configured per bandwidth part (BWP).

Examples of expected WTRU behavior based on the determined waveform are provided herein. Examples of expected WTRU behavior may be a DMRS structure and bundling type (e.g., subband or wideband) or channel state information (CSI) reporting (assuming in an indicated waveform). For example, a DFT-S-OFDM transmission may support (e.g., may only support) type 1 DMRS and/or wideband bundling. Different CSI reporting parameters may be supported (e.g., wideband or subband), such as power offset/back-off/headroom (e.g., per precoding matrix indication (PMI) in CSI reporting or CSI reporting configuration. In examples, the CSI reporting may be based on a WTRU report/recommendation on waveform selection, frequency resources (e.g., adjacent/subset subbands), or CSI report setting (including waveform in the setting). In examples, the CSI reporting may be based on an application of different a codebook subset restriction (CBSR) for a CP-OFDM/DFT-S-OFDM waveform or PC (power ratio between CSI-RS/SSB) or dynamic indication of CBSR. In examples, the CSI reporting may be based on a dynamic indication of power offset (e.g., based on an explicit indication in one or more of an RRC, a MAC CE, or DCI or based on an implicit indication).

Examples of dynamic waveform switching in higher frequencies are provided herein. In higher frequency bands, efficient transmission power handling may be needed as high transmission power may be required to overcome increased pathloss. Power amplifier efficiency may degrade with increasing frequency. Reducing power backoff may be desired, however, and CP-OFDM waveforms in DL NR may require high PAPR and a corresponding large backoff for signal transmission. Utilization of single carrier waveforms including a DFT-s-OFDM waveform and a single carrier-quadrature amplitude modulation (SC-QAM) waveform may be proposed for higher frequency bands. According to various evaluation results, single carrier waveforms may provide performance benefits in low modulations and a line of sight (LOS) environment. Single carrier waveforms, however, may not provide benefits in high modulations (which may be due to increased peak to average power ratio (PAPR) and corresponding large power backoff) and a non-line of sight (NLOS) environment (which may be due to inter-symbol interference from multi-paths). Examples associated with a WTRU efficiently supporting multiple waveforms in higher frequencies are provided herein.

Examples of hybrid initial access by using single carrier waveforms and a CP-OFDM waveform are provided herein. Initial access related signals for both a DFT-S-OFDM waveform and a CP-OFDM waveform may be transmitted. The initial access related signals may include one or more of: a PSS for hybrid operation; a PRACH resource for waveform determination; a SSS with a DFT-S-OFDM waveform and m-sequence for a DFT-S-OFDM based initial access waveform; a PBCH with a DFT-S-OFDM waveform; a CORESET structure including CORESET #0; or a MSG3 in DFT-S-OFDM.

The PSS for hybrid operation may be a PSS based on a Zadoff-Chu signal. If the WTRU blindly detects a Zadoff-Chu signal based PSS, the WTRU may determine a DFT-S-OFDM based initial access waveform. The PSS for hybrid operation may be a waveform type indication based on one or more of: a PSS index (e.g., preamble); a SSB pattern (e.g., time gap between PSS and SSS); or a sync raster. The WTRU may determine the waveform for initial access based on the detected PSS index and/or sync raster. The PSS for hybrid operation may be a WTRU prioritization on a CP-OFDM based initial access waveform operation. The WTRU may include low implementation WTRUs in a CP-OFDM waveform or advanced WTRUs for a CP-OFDM waveform and a DFT-S-OFDM waveform. The PSS for hybrid operation may include frequency resources (e.g., other frequency resources) to utilize.

The PRACH resource for waveform determination may be determined by a WTRU based on a selection of the PRACH resource. The WTRU determination may be reported. For the SSS with a DFT-S-OFDM waveform and m-sequence for a DFT-S-OFDM based initial access waveform, based on the determined initial access waveform, the WTRU may apply IDFT for SSS decoding. For the PBCH with a DFT-S-OFDM waveform, based on the determined initial access waveform, the WTRU may apply IDFT for SSS decoding. If the PSS and SSS are common for both a CP-OFDM waveform and a DFT-S-OFDM waveform, a MIB may indicate a waveform type for initial access. For the CORESET structure including CORESET #0, based on the determined initial access waveform, the WTRU may detect (e.g., blindly detect) a PDCCH based on different CORESET structures. For a DFT-S-OFDM waveform, PDCCH data symbols and DMRS symbols may be independent for a new REG design. For a MSG3 in a DFT-S-OFDM waveform, whether to use a CP-OFDM waveform or a DFT-S-OFDM waveform may be configurable by an RRC configuration. If the WTRU determines a DFT-S-OFDM based initial access waveform, the WTRU may (e.g., may always) use DFT-S-OFDM MSG3.

The transmission of initial access related signals for both a DFT-S-OFDM waveform and a CP-OFDM waveform may be based on one or more of: carrier frequency; frequency bands; subcarrier spacing; etc. The transmission of initial access related signals for both a DFT-S-OFDM waveform and a CP-OFDM waveform may include frequency domain multiplexing of PSS/SSS to reduce time domain resource overhead. The transmission of initial access related signals for a DFT-S-OFDM waveform and a CP-OFDM waveform may include multiple transmitters to maintain a same amount of back-off (e.g., one PA for SSB, another PA for PDSCH).

Examples of slot level dynamic switching between different waveforms are provided herein. Slot level dynamic switching may include slot format configuration/indication for waveform types (e.g., CP-OFDM, DFT-S-OFDM or flexible). The CP-OFDM slot (e.g., which is not flexible) may include initial access related signals, CORESET/SS, and RSs for a CP-OFDM waveform. The DFT-S-OFDM slot (e.g., which is not flexible) may include initial access related signals, CORESET/SS, and RSs for a DFT-S-OFDM waveform. The flexible slot may be without signals for initial access and RSs, so the WTRU may determine slot format based on the dynamic indication (e.g., symbol level dynamic switching). Waveform determination may be based on the indicated slot format. Application of waveform specific designs may be based on the determined waveform.

Examples of symbol level dynamic switching between different waveforms (e.g., DFT-S-OFDM and CP-OFDM) are provided herein. A WTRU may determine a waveform for PDSCH reception based on one or more of following: a TCI state (e.g., an explicit configuration in a TCI state) (e.g., SC-waveform for wider beam to achieve better coverage and CP-OFDM for narrow beam); a PDSCH scheduling (e.g., MCS, FDRA (e.g., scheduled RBs), or a TDRA (e.g., explicit configuration in TDRA)). Examples of BWP level dynamic switching between different waveforms are provided herein. The waveform may be configured per BWP.

Examples of expected WTRU behavior based on the determined waveform are provided herein. Examples of expected WTRU behavior may be a DMRS structure and bundling type (e.g., subband or wideband) or CSI reporting (assuming in indicated waveform). A DFT-S-OFDM transmission may support (e.g., may only support) type 1 DMRS and/or wideband bundling. Different CSI reporting parameters may be supported (e.g., wideband or subband), such as power offset/back-off/headroom (e.g., per PMI) in CSI reporting or CSI reporting configuration. In examples, the CSI reporting may be based on at least one of a WTRU report/recommendation on waveform selection, frequency resources (e.g., adjacent/subset subbands), or a CSI report setting (including waveform in the setting). In examples, the CSI reporting may be based on at least one of an application of a different CBSR for CP-OFDM/DFT-S-OFDM waveforms, a PC (power ratio between CSI-RS/SSB), or a dynamic indication of CBSR. In examples, the CSI reporting may be based on dynamic indication of power offset.

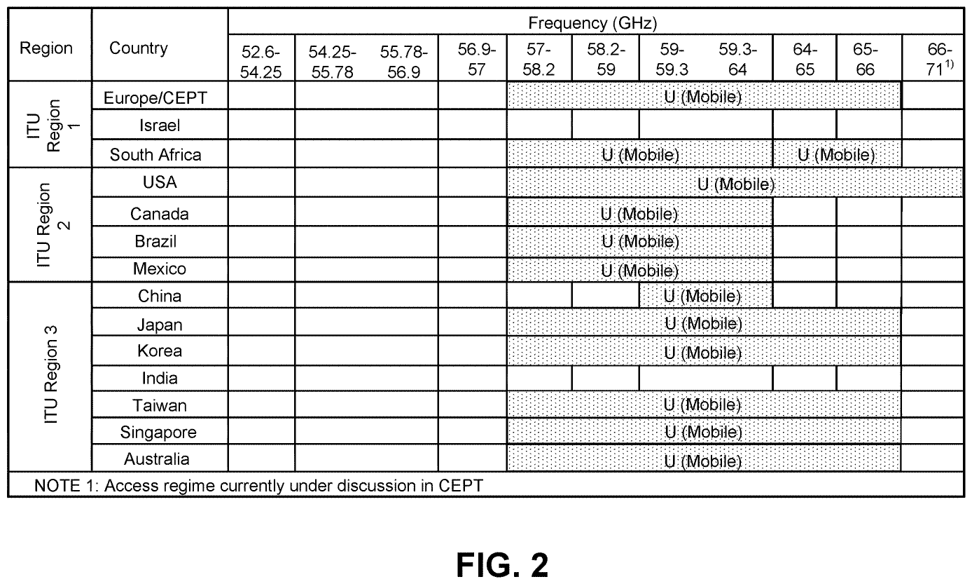

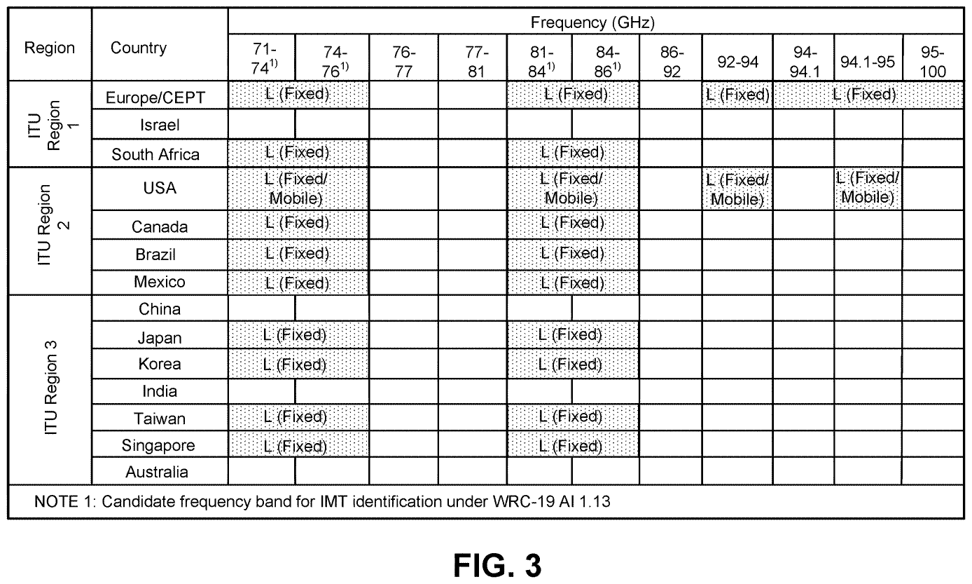

FIG. 2 illustrates example available frequencies between 52.6 GHz and 71 GHz. FIG. 3 illustrates example available frequencies between 71 GHz and 100 GHz. In examples, (e.g., New Radio (NR)) beyond 52.6 GHz may be provided. There may be a minimum 5 GHz of spectrum available globally, between 57 to 64 GHz for unlicensed operation, and in some countries up to 14 GHz of spectrum, between 57 and 71 GHz for unlicensed operation. There may be an identified minimum of 10 GHz of spectrum available globally, between 71 to 76 GHz and 81 to 86 GHz for licensed operation, and in some countries up to 18 GHz of spectrum available, between 71 and 114.25 GHz for licensed operation. Frequency ranges above 52.6 GHz may include larger spectrum allocations and larger bandwidths may not be available for bands lower than 52.6 GHz. Physical layer channels of NR may be designed to be optimized for uses under 52.6 GHZ.

To enable and optimize NR systems, frequencies above 52.6 GHz may be faced with challenges, such as higher phase noise, extreme propagation loss due to high atmospheric absorption, lower power amplifier efficient, and strong power spectral density regulatory requirements, compared to lower frequency bands.

Efficient transmission power handling may be desired as high transmission power may be required to overcome increased pathloss in higher frequency bands. However, power amplifier efficiency may degrade with increasing frequency. Given the reduced efficiency of power amplifier, reducing power backoff may be desired in higher frequency bands. However, cyclic prefix-orthogonal frequency domain multiplexing (CP-OFDM) in DL (e.g., in downlink NR, which may be used as an example herein) may require high peak-to-average power ratio (PAPR) and corresponding large backoff for signal transmission. Utilization of single carrier waveforms may include a DFT-s-OFDM and a SC-QAM for higher frequency bands. Single carrier waveforms may provide performance benefits in low modulations and LOS environment with low PAPR. Single carrier waveforms, however, may not provide benefits in high modulations (which may be due to increased PAPR and corresponding large power backoff) a NLOS environment (which may be due to inter-symbol interference from multi-paths).

Examples of enabling initial access procedure based on multiple waveforms are provided herein. Examples of enabling slot level dynamic switching between different waveforms are provided herein. Examples of enabling symbol level dynamic switching between different waveforms are provided herein. Examples of enabling BWP level dynamic switching between different waveforms are provided herein. Examples of enabling CSI reporting based on multiple waveforms are provided herein.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a synchronization signal (SS) block. The WTRU transmission may be referred to as a “target,” and the received RS or SS block may be referred to as a “reference” or a “source.” The WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as a “target” and a “reference” (or “source”), respectively. The WTRU may be said to transmit the first (target) physical channel or signal according to a spatial relation with a reference to the second (reference) physical channel or signal.

A spatial relation may be implicit, configured by an RRC, or signaled by a MAC CE or DCI. In examples, a WTRU may (e.g., may implicitly) transmit PUSCH and DM-RS of PUSCH according to the same spatial domain filter as a sounding reference signal (SRS) indicated by a SRS resource indicator (SRI) indicated in DCI or configured by an RRC. In examples, a spatial relation may be configured by an RRC for an SRI or signaled by a MAC CE for a PUCCH. Spatial relations may (e.g., may also) be referred to as a “beam indication.”

The WTRU may receive a first (target) downlink channel or signal according to the same spatial domain filter or spatial reception parameter as a second (reference) downlink channel or signal. An association may exist between a physical channel such as a PDCCH or a PDSCH and its respective DM-RS. At least if the first and second signals are reference signals, association may exist if the WTRU is configured with a quasi-colocation (QCL) assumption type D between corresponding antenna ports. An association (e.g., such association) may be configured as a Transmission Configuration Indicator (TCI) state. A WTRU may indicate an association between a CSI-RS or a SS block and a DM-RS by an index to a set of TCI states configured by an RRC and/or signaled by a MAC CE. An indication (e.g., such indication) may (e.g., may also) be referred to as a “beam indication.”

Examples of hybrid initial access based on multiple waveforms are provided herein. A new waveform may be interchangeably used with one or more of a DFT-s-OFDM waveform, (single carrier frequency domain multiple access) SC-FDMA waveform, a N x SC-FDMA waveform, a clustered DFT-s-OFDM waveform, a SC-QAM waveform, a single carrier-frequency domain equalization (SC-FDE) waveform, a filter bank multi-carrier (FBMC) waveform, or a universal filtered multi-carrier (UFMC) waveform. A signal may be interchangeably used with one or more of following: an SRS, channel state information-reference signal (CSI-RS), a DM-RS, a phase tracking reference signal (PT-RS), or an SSB. A channel may be interchangeably used with one or more of following: a PDCCH, a PDSCH, a physical uplink control channel (PUCCH), a physical uplink shared channel (PUSCH), a physical random access channel (PRACH), etc. A WTRU may determine a waveform for initial access. The WTRU may apply the determined waveform for initial access procedures (e.g., remaining initial access procedures after the detection). The determination may be based on one or more of following: parameters of synchronization signals, associated PRACH resources and/or PRACH sequences, physical broadcasting channel (PBCH) parameters, CORESET/search space configurations of CORESET #0/search space #0, carrier frequency, frequency band and/or frequency range (FR2-1 or FR2-2), or subcarrier spacing (SCS).

The parameters of synchronization signals may include multiplexing pattern of synchronization signals. The WTRU may determine a first waveform (e.g., CP-OFDM) if the WTRU detects a first SSB pattern (e.g., frequency domain multiplexing (FDM)). The WTRU may determine a second waveform (e.g., new waveform) if the WTRU detects a second SSB pattern (e.g., time-domain multiplexing (TDM)).

For associated PRACH resources and/or PRACH sequences, the WTRU may report its preferred waveform for initial access by transmitting one or more PRACHs in associated PRACH resources/sequences. If the WTRU determines to use a first waveform (e.g., CP-OFDM), the WTRU may transmit one or more PRACHs in a first PRACH resource and/or with a first PRACH sequence. If the WTRU determines to use a second waveform (e.g., new waveform), the WTRU may transmit one or more PRACHs in a second PRACH resource and/or with a second PRACH sequence.

For the PBCH parameters, the WTRU may determine a waveform for initial access based on a PBCH. The WTRU may determine a waveform based on one or more of following parameters of PBCH: a PBCH DMRS pattern; a PBCH DMRS sequence; or a MIB.

For the PBCH DMRS pattern, the WTRU may determine a waveform based on a PBCH DMRS pattern. The WTRU may determine a first waveform if the WTRU detects a first PBCH DMRS pattern. The WTRU may determine a second waveform if the WTRU detects a second PBCH DMRS pattern.

For the PBCH DMRS sequence, the WTRU may determine a waveform based on a PBCH DMRS sequence type. The WTRU may determine a first waveform if the WTRU detects a first type of PBCH DMRS sequence. The WTRU may determine a second waveform if the WTRU detects a second type of PBCH DMRS sequence.

For the MIB, a field in the MIB may indicate a waveform type for initial access.

For the CORESET/search space configurations of CORESET #0/search space #0, the WTRU may determine a waveform for initial access based on CORESET #0/search space #0 configurations. The WTRU may determine a waveform based on one or more of following configurations of CORESET #0/search space #0: an explicit indication of a CORESET #0/search space #0 configuration; a SS/PBCH block and control resource set multiplexing pattern; a number of RBs; a number of symbols; an offset; or the thresholds X, Y, Z based on one or more of predefined values, configured values by a gNB, and WTRU reported values (e.g., via WTRU capability signaling).

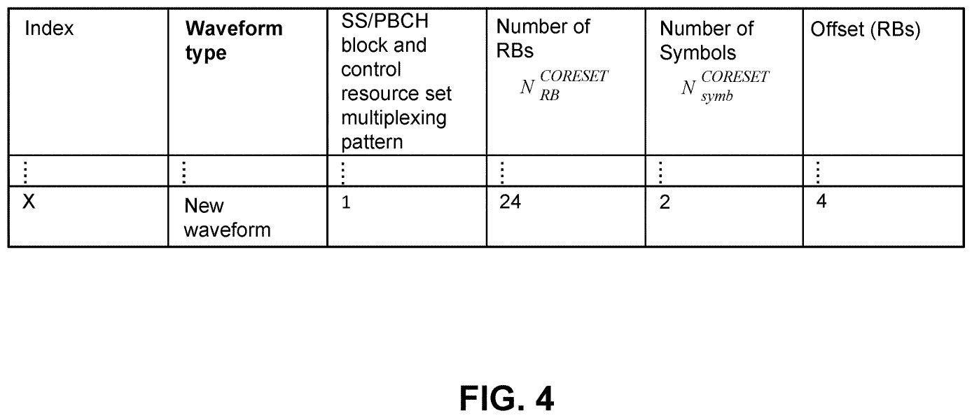

FIG. 4 illustrates an example waveform type indication in a CORESET/search space configuration table. For an explicit indication of a CORESET #0/search space #0 configuration, a column of CORESET #0/search space #0 configuration may indicate a waveform type. The WTRU may receive an index of CORESET #0/search space #0 configuration. Based on the index, the WTRU may determine a waveform type for initial access.

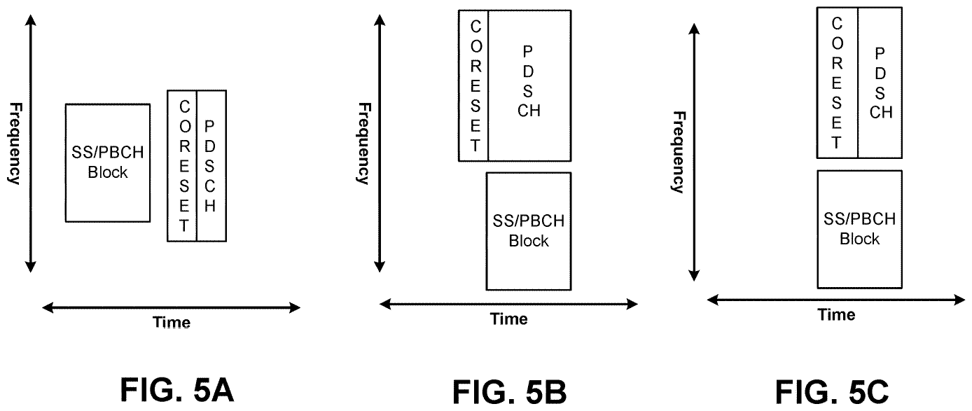

FIGS. 5A-5C illustrate examples of different CORESET/search multiplexing patterns. For a SS/PBCH block and control resource set multiplexing patterns, the WTRU may determine a waveform based on an indicated SS/PBCH block and a control resource set multiplexing pattern. If the indicated multiplexing pattern is a first multiplexing pattern (e.g., pattern 1 or time domain duplexing (TDD) as shown in FIG. 5A), the WTRU may determine a first waveform. If the indicated multiplexing pattern is a second multiplexing pattern (e.g., pattern 2/3 or TDD and/or FDD as shown in FIGS. 5B-5C), the WTRU may determine a second waveform.

For the number of RBs, the WTRU may determine a waveform based on an indicated number of RBs of CORESET #0/search space #0. If the indicated number of RBs is larger than a threshold X, the WTRU may determine a first waveform. If the indicated number of RBs is smaller than (or equal to) the threshold X, the WTRU may determine a second waveform.

For the number of symbols, the WTRU may determine a waveform based on an indicated number of symbols of CORESET #0/search space #0. If the indicated number of symbols is larger than a threshold Y, the WTRU may determine a first waveform. If the indicated number of symbols is smaller than (or equal to) the threshold Y, the WTRU may determine a second waveform.

For the offset, the WTRU may determine a waveform based on an indicated offset of CORESET #0/search space #0. If the indicated offset is larger than a threshold Z, the WTRU may determine a first waveform. If the indicated offset is smaller than (or equal to) the threshold Z, the WTRU may determine a second waveform.

In examples, the WTRU may apply one or more of following operations for initial access based on a determined waveform: a waveform of SSS, a waveform of message 3(MSG3 ), a different CORESET/search space structures, a different PRACH resources and/or PRACH sequences, or a different SCS.

For waveform of SSS, the WTRU may determine a waveform of SSS based on the detected waveform of PSS. If the WTRU detects a first waveform (e.g., CP-OFDM), the WTRU may blindly detect SSS sequences (e.g., m sequences) without application of IDFT. If the WTRU detects a second waveform (e.g., new waveform), the WTRU may apply IDFT before SSS detection or detect SSS by assuming different sequences (e.g., Zadoff-Chu sequence).

For a waveform of message 3(MSG3 ), the WTRU may determine a waveform of MSG3 based on the determined waveform. If the WTRU determines a first waveform (e.g., CP-OFDM), the WTRU may transmit MSG3 based on a gNB configuration (whether to use the first waveform or a second waveform e.g., msg3-transformPrecoding). If the WTRU determines a second waveform (e.g., new waveform), the WTRU may apply DFT precoding for a MSG3 transmission regardless of the gNB configuration.

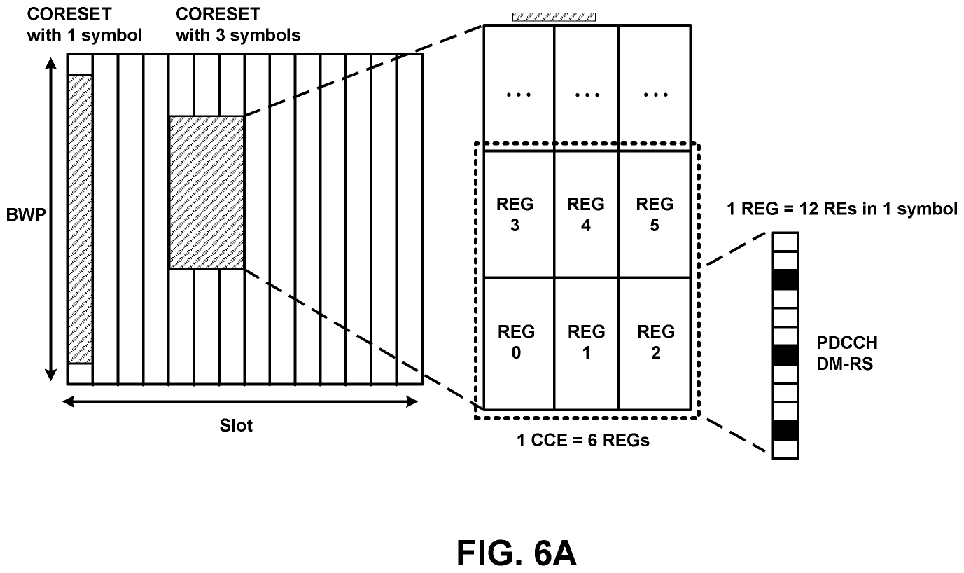

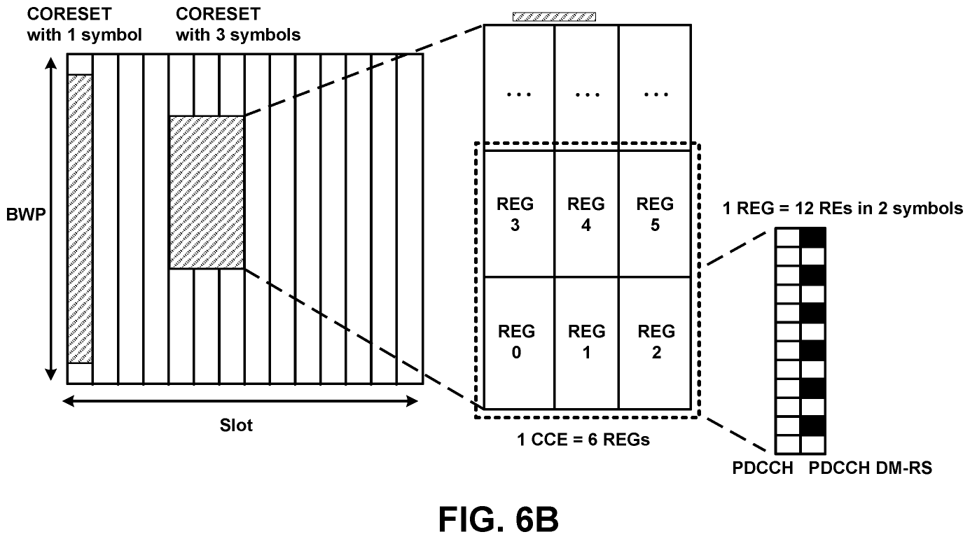

FIGS. 6A-6B illustrate examples of different CORESET/search space structures. For the different CORESET/search space structures, the WTRU may assume different CORESET/search space structures for blind detection of PDCCHs. If the WTRU determines a first waveform (e.g., CP-OFDM), the WTRU may assume an REG in a symbol with frequency domain multiplexed (FDMed) control information and a PDCCH DM-RS. If the WTRU determines a second waveform (e.g., new waveform), the WTRU may assume an REG in two or more symbols with time domain multiplexed (TDMed) control information and a PDCCH DM-RS.

In examples, the WTRU may assume parameters for a CORESET/search space construction. If the WTRU determines a first waveform (e.g., CP-OFDM), the WTRU may assume a first parameter for a CORESET/search space construction. If the WTRU determines a second waveform (e.g., new waveform), the WTRU may assume a second parameter for a CORESET/search space construction. The parameter may be one or more of following: number of REGs per CCE, minimum and/or maximum durations of CORESET, or number of REs per REG (e.g., 6 or 12).

In examples, the WTRU may apply the determined waveform for control information of PDCCH. If the WTRU detects a first waveform (e.g., CP-OFDM), the WTRU may blindly detect PDCCH without application of an IDFT. If the WTRU detects a second waveform (e.g., new waveform), the WTRU may apply an IDFT before PDCCH detection.

For the different PRACH resources and/or PRACH sequences, the WTRU may transmit one or more PRACHs in associated PRACH resources/sequences with the determined waveform type. If the WTRU determines a first waveform (e.g., CP-OFDM), the WTRU may transmit one or more PRACHs in a first PRACH resource and/or with a first PRACH sequence. If the WTRU determines a second waveform (e.g., new waveform), the WTRU may transmit one or more PRACHs in a second PRACH resource and/or with a second PRACH sequence.

For the different SCS, the WTRU may determine a SCS based on the determined waveform type. If the WTRU determines a first waveform (e.g., CP-OFDM), the WTRU may use a first SCS (e.g., 120 kHz) for its operation. If the WTRU determines a second waveform (e.g., new waveform), the WTRU may use a second SCS (e.g., 480 kHz or 960 kHz) for its operation.

Examples of primary synchronization signal for hybrid waveform operation are provided herein. A WTRU may receive an SS/PBCH block (SSB). The SS/PBCH block may carry one or more of: a PSS, a SSS, a PBCH, or PBCH DMRS. The term PSS may be used to represent the content, information, payload, and/or a sequence of bits. The PSS sequence may be used to extract the strongest correlation spike as the first step in SS/PBCH block recovery and cell search.

In examples, the sequence for the PSS may be an m-sequence with length-127, generated based on the cell ID (e.g., NID2∈{0,1,2}). The PSS sequence may be generated as d_PSS(n)=1-2x(m) based on the generator polynomial x(i+7)={(x(i+4)+x(i) mod 2}, and three cyclic shifts with m={(n+43*NID2) mod 127}, where 0<=n<127. The WTRU may expect to receive the PSS sequence within one SS/PBCH block, mapped in the first symbol relative to the start of the SS/PBCH block in time, and through subcarrier numbers 56-182 relative to the start of the SS/PBCH block in frequency.

During the cell search, a WTRU may use synchronization raster to determine the frequency positions of the SS/PBCH block (e.g., if explicit signaling of the SS/PBCH block is not present). The WTRU may generate possible sequences (e.g., all possible sequences) for the PSS and then perform corresponding correlation functions to detect the strongest peak. If detection of a correlation peak is successful, the WTRU may determine the respective PSS sequence and the corresponding cell ID (e.g., NID2).

In examples, the reference PSS sequences may be centered in a frequency relative to the SS/PBCH block frequency allocation. If detection of the PSS is successful, the WTRU may determine a frequency offset (e.g., primary frequency offset) relative to the center frequency of the carrier. The WTRU may estimate the synchronization time offset (e.g., via a timer) based on the detected PSS sequence. The WTRU may use the determined frequency and time offsets (e.g., via a timer) for the reception procedure and OFDM demodulation of the content (e.g., remaining content) of the SS/PBCH block.

Hereafter, the terms PSS, SS/PBCH block, SSS, PBCH, and PBCH DM-RS may be used interchangeably.

In operation in higher frequencies, a WTRU may need to support multiple waveforms. The waveforms may be based on OFDM modulation with transform precoding enabled or not enabled. The transmission procedure where transform precoding is enabled may be used interchangeably with a DFT-S-OFDM waveform, a SC-FDMA waveform, or a SC-QAM waveform. The transmission procedure where transform precoding is not enabled may be used interchangeably with a CP-OFDM waveform.

When operating in high frequencies, the WTRU may support multiple waveforms. As such, the WTRU may need to identify and support the modes of operation based on different waveforms during the initial access.

Examples of modes of operation indications based on PSS sequence generation are provided herein. One or more sequence generation sets may be used, defined, configured, or determined, where each sequence set may be associated with a mode of operation.

A WTRU may perform the (e.g., blind) detection based on the different sequence sets during the system acquisition. If the WTRU detects a PSS sequence based on the first sequence generation set, the WTRU may perform a first mode of operation associated with the first sequence generation set. If the WTRU detects a PSS sequence based on the second sequence generation set, the WTRU may perform a second mode of operation associated with the second sequence generation set, and so forth.

The m-sequence may be used as one of the sequence generation sets for PSS generation. If the WTRU identifies that PSS sequence is generated based on an m-sequence set, the WTRU may determine to operate based on the mode of operation that is associated with detection of the m-sequence for the PSS sequence (e.g., a transmission and/or reception procedure based on a CP-OFDM waveform).

The Zadoff-Chu sequence may be used as a set (e.g., as another set) for the PSS sequence generation. If the WTRU identifies that a PSS sequence is generated based on a Zadoff-Chu sequence set, the WTRU may determine to operate based on the mode of operation that is associated with detection of the Zadoff-Chu generated PSS (e.g., a transmission and/or reception procedure based on a DFT-S-OFDM waveform).

In examples, a Zadoff-Chu sequence for the PSS may be generated by d_PSS(n)=xu((n+C) mod 127), wherein 0<=n<127 and u is the preconfigured root sequence. The xu is the generator polynomial that may be defined as xu(i)=exp(−jπi(i+1)/127). The parameter C is the cyclic shift that may be defined as C={(n+43*NID2) mod 127}, for NID2∈{0,1,2}.

Examples of modes of operation indications based on PSS index, SS/PBCH block pattern, and sync raster are provided herein. A WTRU may identify one or more modes of operation based on the parameters and indices used in generation of a PSS sequence. Different ranges and/or thresholds values for the different parameters in a PSS sequence generation may be used, defined, configured, or determined. A range and/or threshold may be mutually exclusive to another range and/or threshold.

If detection of a PSS sequence during the system acquisition is successful, a WTRU may determine the parameters used in generation of the PSS sequence. If the WTRU detects a PSS sequence generated based on parameters within a first range and/or threshold, the WTRU may perform a first mode of operation associated with the first range and/or threshold. If the WTRU detects a PSS sequence generated based on the parameters within a second range and/or threshold, the WTRU may perform a second mode of operation associated with the second range and/or threshold, and so forth.

In examples, one or more values for the cell id (e.g., NID2) may be used, defined, configured, or determined to generate the PSS sequence based on the m-sequences, where the cell-id (e.g., NID2) may be used to indicate the mode of operation. If a WTRU determines that the detected NID2 from a PSS sequence belongs to a first set of values, the WTRU may determine to operate based on a first mode of operation. If the WTRU determines that the detected NID2 from a PSS sequence belongs to a second set of values, the WTRU may determine to operate based on a second mode of operation.

In examples, one or more values for the root sequence and/or cell id (e.g., NID2) may be used, defined, configured, or determined to generate a PSS sequence based on Zadoff-Chu sequences, where the cell-id (e.g., NID2) may be used to indicate the mode of operation. If a WTRU determines that the detected root sequence and/or NID2 from a PSS sequence belongs to a first set of values, the WTRU may determine to operate based on a first mode of operation. If the WTRU determines that the detected root sequence and/or NID2 from a PSS sequence belongs to a second set of values, the WTRU may determine to operate based on a second mode of operation.

In examples, one or more synchronization raster sets may be used, defined, configured, or determined, where the synchronization raster sets (e.g., each of the synchronization raster sets) may be a subset of a channel raster. Synchronization raster sets (e.g., two sets) may be used, defined, or configured corresponding to a channel raster. One or more of following may apply: a synchronization raster set may be mutually exclusive to another synchronization raster set; a synchronization raster may be determined based on the step size that may be an integer multiple of the channel raster step size (e.g., the multiple coefficients corresponding to a synchronization raster set may be different from the multiple coefficients corresponding to another synchronization raster set); a synchronization raster may be determined based the starting offset corresponding to the channel raster, where the starting offset corresponding to a synchronization raster set may be different from the starting offset corresponding to another synchronization raster set; first RF reference frequencies may be used for a first synchronization raster set and second RF reference frequencies may be used for a second synchronization raster set (e.g., first RF reference frequencies may be mutually exclusive to the second RF reference frequencies); or the number of synchronization raster sets used for an operating band may be determined based on frequency band, duplex mode (e.g., TDD or FDD), and/or geographical location (e.g., country, zone, zone identity).

One or more synchronization raster sets may be used, and the synchronization raster sets (e.g., each synchronization raster set) may be associated with a mode of operation. If a WTRU detects a SS/PBCH block or the corresponding PSS in a first synchronization raster set, the WTRU may perform a first mode of operation associated with the first synchronization raster set. If the WTRU detects a synchronization signal in a second synchronization raster set, the WTRU may perform a second mode of operation associated with the second synchronization raster set, and so forth.

One or more patterns for the SS/PBCH block may be used, defined, configured, or determined. SS/PBCH block patterns (e.g., each SS/PBCH block pattern) may be associated with a mode of operation. In examples, a SS/PBCH block pattern may include PSS sequences with length longer than 127. There may be time gap between the PSS and SSS within the same SS/PBCH block. If a WTRU detects a SS/PBCH block or the corresponding PSS with the first SS/PBCH block pattern, the WTRU may perform a first mode of operation associated with the first pattern. If the WTRU detects a SS/PBCH block or the corresponding PSS with the second SS/PBCH block pattern, the WTRU may perform a second mode of operation associated with the second SS/PBCH block pattern, and so forth.

Examples of modes of operations in the hybrid waveform operation are provided herein. The modes of operation may include one or more of the following: SSS reception, PBCH reception, SS/PBCH block (SSB) configuration, CORESET #0 configuration, Type-0 PDCCH search space monitoring, or transform precoding and/or waveform configuration.

For the SSS reception, if the WTRU determines that the detected SS/PBCH block or PSS indicates a first mode of operation, the WTRU may detect or receive the respective SSS in the first mode of operation. If the WTRU determines that the detected SS/PBCH block or PSS indicates a second mode of operation, the WTRU may detect or receive the respective SSS in the second mode of operation. The reception procedure and/or demodulation for SSS may be different based on the mode of operation. The set of sequences for SSS may be different based on the mode of operation. The time and frequency allocation of SSS may be different based on the mode of operation. The channel estimation based on the SSS and determination of the strongest received SSS may be different based on the mode of operation.

For the PBCH reception, if the WTRU determines that the detected SS/PBCH block or PSS indicates a first mode of operation, the WTRU may detect or receive the respective PBCH in the first mode of operation. If the WTRU determines that the detected SS/PBCH block or PSS indicates a second mode of operation, the WTRU may detect or receive the respective PBCH in the second mode of operation. The reception procedure including the equalization and/or demodulation for PBCH may be different based on the mode of operation. The time and frequency allocation of PBCH may be different based on the mode of operation. The reception procedure for PBCH DM-RS may be different based on the mode of operation. The set of sequences for PBCH DM-RS may be different based on the mode of operation. The time and frequency allocation of PBCH DMRS may be different based on the mode of operation. The channel estimation based on the PBCH DM-RS, a determination of the strongest PBCH DM-RS (e.g., based on the received SNR), and an identification the index of the respective PBCH DM-RS may be different based on the mode of operation.

For the SS/PBCH block (SSB) configuration, the time and frequency allocation for the SS/PBCH block may be different based on the mode of operation. The reception procedure and/or demodulation for the SS/PBCH block may be different based on the mode of operation. A WTRU may perform the SS/PBCH block detection based on the mode of operation that the WTRU has determined from the detected PSS.

For the CORESET #0 configuration, the time and frequency allocation for the CORESET #0 associated with the detected SS/PBCH block may be different based on the mode of operation. This may include the multiplexing pattern, a number of Resource Blocks (RBs), a number of symbols, and the offset in the number of RBs. The reception procedure and/or demodulation for the CORESET #0 may be different based on the mode of operation. A WTRU may perform the monitoring and CORESET #0 detection based on the mode of operation that the WTRU has determined from the detected PSS.

For the Type-0 PDCCH search space monitoring, the time and frequency allocation for the Type-0 PDCCH search space associated with the detected SS/PBCH block may be different based on the mode of operation. The reception procedure and/or demodulation for the Type-0 PDCCH search space may be different based on the mode of operation. A WTRU may perform the monitoring and Type-0 PDCCH detection based on the mode of operation that the WTRU has determined from the detected PSS.

For the transform precoding and/or waveform configuration, a WTRU may perform the reception procedure assuming that the transform precoding was enabled (e.g., DFT-S-OFDM) in the first mode of operation. The WTRU may perform the reception procedure assuming that the transform precoding was not enabled (e.g., CP-OFDM) in the second mode of operation.

One or more PSS sequence sets, synchronization raster sets, and/or SS/PBCH block configurations may be used and a WTRU may determine at least one of following based on the PSS, synchronization set and/or SS/PBCH block the WTRU received, detected, or determined for initial access: a waveform configuration, a transform precoding configuration, a licensed spectrum or unlicensed spectrum, a PBCH type (e.g., which information is included in the PBCH), a duplex mode (e.g., TDD, FDD, or HD-FDD), a PRACH resource configuration, a range of the system bandwidth, a use case (e.g., sidelink, Uu, NTN, etc.), a maximum uplink transmission power, a barring of WTRU types, or support of a specific functionality in the network (e.g., power saving, carrier aggregation, DRX, etc.). For the barring of WTRU types (e.g., access baring of a certain WTRU types), a first type of WTRUs (e.g., a WTRU with a limited capability including reduced Rx antenna, smaller maximum bandwidth supported, lower maximum transmission power) may not be allowed to access the cell if the SSB is located in a first sync raster set. Otherwise, the first type of WTRUs may be allowed to access the cell.

Examples of slot level dynamic switching between different waveforms (e.g., waveform types) are provided herein. Slot format configuration information (e.g., a slot format indication) for different waveform types associated with multiple slots (e.g., CP-OFDM, DFT-S-OFDM, or flexible) may be included. The slot format configuration (e.g., the slot format indication) may indicate whether a particular waveform (e.g., a first waveform type or a second waveform type) is indicated for a slot or whether the slot is indicated as flexible. In examples, a first waveform type associated with a first slot may be a CP-OFDM waveform and a second waveform type associated with a second slot may be a DFT-s-OFDM waveform. In examples, a first waveform type associated with a first slot may be a DFT-s-OFDM waveform and a second waveform type associated with a second slot may a CP-OFDM waveform. If the second waveform type associated with the second slot is a CP-OFDM waveform, the second slot may include (e.g., carry) initial access related signals, CORESET/SS, and/or RSs for the CP-OFDM waveform. If the second waveform type associated with the second slot is a DFT-s-OFDM waveform, the second slot may include (e.g., carry) initial access related signals, CORESET/SS, and/or RSs for the DFT-S-OFDM waveform. A flexible slot may not carry signals for initial access and RSs. The WTRU may determine a slot format (e.g., determine a waveform type associated with a slot) based on a dynamic indication, for example, symbol level dynamic switching (e.g., the slot format may be controlled in a symbol level and not in a slot level, for example, a number of symbols may be indicated for a waveform type). Examples of waveform determination based on the indicated slot format are provided herein.

A resource may be interchangeably used with one or more of a channel, a signal, and a symbol.

Examples of slot format configuration information (e.g., a slot format indication) for dynamic waveform determination are provided herein. A WTRU may receive slot format configuration information (e.g., a slot format indication) for multiple waveform types associated with multiple slots (e.g., each slot may be indicated to be associated with a CP-OFDM waveform, a DFT-S-OFDM waveform, or be indicated to be flexible as to waveform type). Based on the slot format configuration information (e.g., the slot format indication), the WTRU may receive a dynamic indication of waveform types for one or more resources. The slot format configuration information (e.g., a slot format indication) may be based on (e.g., received via) one or more of the following: an RRC configuration; a MAC CE; or DCI (a WTRU-specific DCI and/or group DCI).

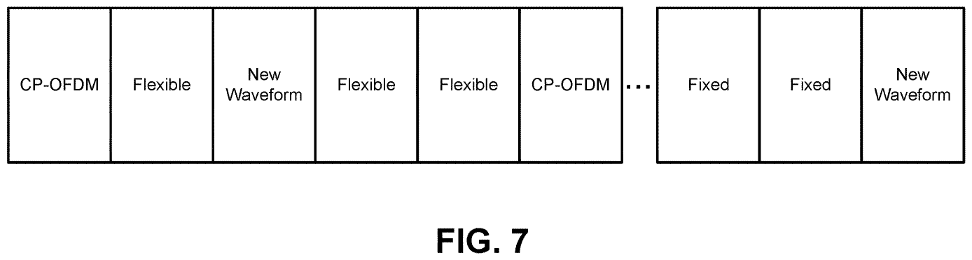

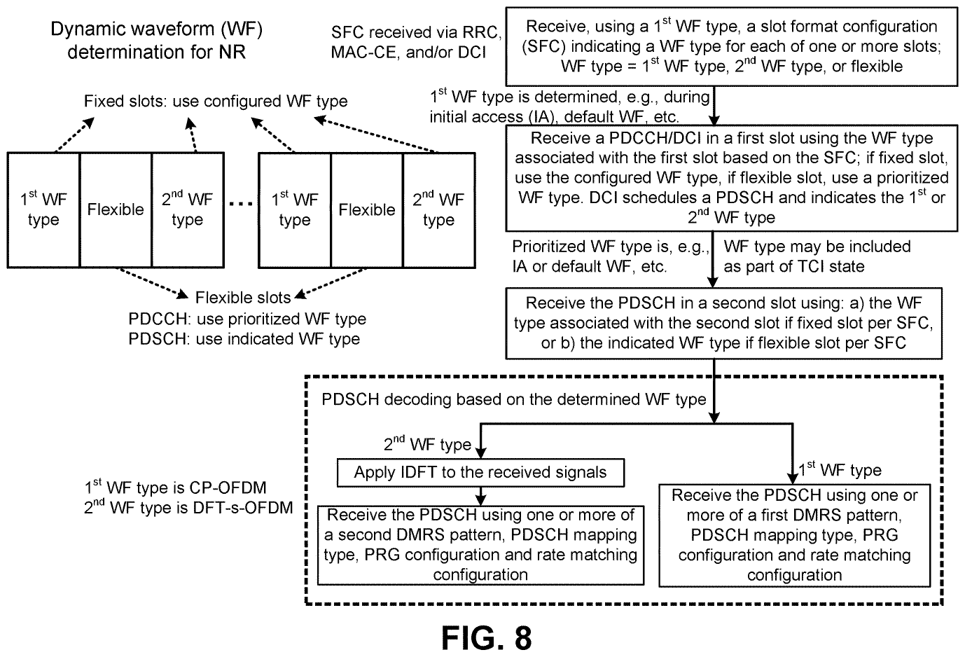

FIGS. 7-8 illustrate slot format configuration information (e.g., a slot format indication) associated with multiple waveforms associated with multiple slots (e.g., as shown, each slot may be indicated to be associated with a first waveform type, a second waveform type, or be indicated to be flexible as to waveform type). For example, a given slot, a particular waveform type may be indicated for the slot or the slot may be indicated as flexible. In examples, the waveform types may include a CP-OFDM waveform or a DFT-s-OFDM waveform. If the slot is indicated as flexible, a waveform type used for the slot may not be fixed and may be chosen, for example based on certain conditions (e.g., such as those described herein).

The slot format configuration information (e.g., the slot format indication) may indicate one or more of following: a first waveform type is associated with a slot (e.g., a CP-OFDM waveform associated with a first slot as shown in FIGS. 7-8), a second waveform type is associated with a slot (e.g., a new waveform associated with a third slot as shown in FIG. 7 or a DTF-s-OFDM waveform associated with a third slot as shown in FIG. 8), or a slot is indicated as flexible (e.g., the second slot as shown in FIGS. 7-8). A slot indicated as a flexible (e.g., the second slot as shown in FIG. 7) may be without signals for initial access and RSs. The WTRU may determine a waveform type in associated with the flexible slot based on a dynamic indication (e.g., symbol level dynamic switching) or a default waveform type (e.g., a predefined waveform type (e.g., a CP-OFDM waveform) or a waveform type which was used for initial access).

The WTRU may receive a PDCCH transmission in a first slot. The PDCCH may be received via a first waveform type if the first waveform type is indicated in the slot format configuration as being associated with the first slot. The first waveform type indicated for the first slot may be indicated as a CP-OFDM waveform (e.g., shown as ‘CP-OFDM’ in FIG. 7). The WTRU may support one or more operations for CP-OFDM waveform if the slot format indication indicates ‘CP-OFDM’. One or more slots associated with ‘CP-OFDM’ may include one or more signals and channels (e.g., one or more of SS/PBCH, search space/CORESETs, CSI-RSs, PRACH resources, PUCCH resources, and SRS) associated with the CP-OFDM waveform. For one or more slots indicated as a first waveform type (e.g., such as ‘CP-OFDM’ as shown in FIG. 7), the WTRU may receive one or more channels and signals (e.g., the PDCCH transmission(s)) by using the first waveform type associated with the first slot (e.g., the CP-OFDM waveform) and associated configurations.

If the slot format configuration information received by the WTRU includes a dynamic indication associated with one or more waveform types, the WTRU may not apply the dynamically indicated waveform types to one or more slots indicated as a first particular waveform (e.g., ‘CP-OFDM’ as shown in FIG. 7). If the slot format configuration information received by the WTRU includes a second waveform type associated with another slot (e.g., a new waveform indication as shown in FIG. 7 or a DFT-s-OFDM waveform as shown in FIG. 8) for one or more channels and/or signals, the WTRU may transmit/receive the channels and/or signals by using the CP-OFDM waveform in the one or more slots indicated as ‘CP-OFDM’.

The WTRU may support one or more operations for a new waveform if the slot format indication indicates a new waveform' for a slot (as shown in FIG. 7). One or more slots associated with the new waveform may include one or more signals and channels (e.g., one or more of SS/PBCH, search space/CORESETs, CSI-RSs, PRACH resources, PUCCH resources, and SRS) with one or more new waveforms (e.g., a DFT-s-OFDM waveform). For one or more slots indicated as new waveform, the WTRU may receive one or more channels and signals by using the new waveform and associated configurations.

If the slot format configuration information received by the WTRU includes a dynamic indication of one or more waveform types, the WTRU may not apply the dynamically indicated waveform types to one or more slots indicated as a new waveform (e.g., as shown in FIG. 7). In examples, if the WTRU receives a new waveform indication for one or more channels and/or signals, the WTRU may transmit/receive the channels and/or signals by using the new waveform in the one or more slots indicated as new waveform. Multiple types of new waveforms may be used. For example, a DFT-s-OFDM waveform (e.g., as shown in FIG. 8) and a SC-QAM waveform may be used as new waveform types.

For the flexible information, if the WTRU receives a dynamic indication of one or more waveform types (e.g., for one or more of resources, signals, and channels), the WTRU may apply the one or more waveform types for the indicated one or more resources, channels, and signals within slots indicated as ‘flexible’. In examples, if the first slot is flexible, the WTRU may receive a PDCCH transmission using a prioritized waveform type (e.g., an initial access waveform or a default waveform). In examples, if the second slot is flexible, the WTRU may receive a PDSCH transmission of an indicated waveform type. For one or more channels and/or signals, the WTRU may transmit/receive the channels and/or signals by using the indicated waveform type within slots indicated as ‘flexible’.

The slot format configuration information (e.g., the slot format indication) may be based on a bitmap or an indication of preconfigured resource types. For the bitmap, the WTRU may receive an indication of one or more waveform types with bitmap. In examples, a codepoint (e.g., each codepoint) for a slot may indicate one of ‘CP-OFDM’, ‘new waveform’, and ‘flexible’ (e.g., as shown in FIG. 7). For the indication of preconfigured resource types, the WTRU may be configured with one or more groups of waveform types. The waveform types (e.g., each waveform type) may indicate a waveform type of a slot. Based on the one or more groups, the WTRU may receive an indication of a group for the operation.

Examples of resource level dynamic switching between different waveforms are provided herein. A WTRU may receive an indication of resource level dynamic switching. The WTRU may receive the indication by receiving one or more: of an RRC configuration, a MAC CE, or DCI. The indication may be based on an explicit indication or an implicit indication.

For the explicit indication, a field may indicate a waveform type of one or more resources (e.g., an indicated waveform type). A field of group DCI or a MAC CE signaling may indicate a waveform type for one or more resources (e.g., an indicated waveform type). In examples, the WTRU may receive the waveform type indication for one or more CORESETs, search spaces, PUCCH resources, and PRACH resources. A field of a WTRU specific DCI may indicate a waveform type for one or more resources (e.g., an indicated waveform type). In examples, the WTRU may receive the waveform type indication for one or more signals and/or channels (e.g., the indicated waveform type) based on a DL/UL scheduling DCI (e.g., DCI that schedules a PDSCH transmission). The WTRU may receive a waveform type indicator (e.g., the indicated waveform type) via a PDCCH transmission that includes the DCI that schedules one or more PDSCHs/PUSCHs transmission(s). The WTRU may apply the indicated waveform type (e.g., which may be one of the first waveform type or the second waveform type) to the one or more PDSCHs/PUSCHs transmission(s) (e.g., for receiving the PDSCH transmission). A MAC CE may signal whether or not an explicit indication is included in DCI.

For the implicit indication, a waveform type may be indicated by using other indication fields. The other indication fields include one or more of: a TCI state, a radio network temporary identifier (RNTI), a FDRA, a TDRA, or an MCS.

For the TCI state, the WTRU may be configured with one or more TCI states and the TCI states (e.g., each TCI state) may include a waveform type configuration. The WTRU may receive an indication of one or more TCI states to transmit/receive one or more signals/channels. Based on the indicated one or more TCI states, the WTRU may determine the associated waveform type to transmit/receive the one or more signals/channels. If a number of TCI states is larger than 1, one (e.g., only one) of the indicated TCI states may include a waveform type. If a number of TCI states is larger than 1 and multiple TCI states indicate waveform types, the WTRU may apply one of the waveform types to transmit/receive the one or more signals/channels. In examples, the WTRU may apply the waveform type of a first TCI state.

For the RNTI, the WTRU may receive a waveform type indication based on the RNTI. If a scheduling PDCCH is scrambled with a first RNTI, the WTRU may use a first waveform type (e.g., a CP-OFDM waveform) to transmit/receive one or more channels/signals. If a scheduling PDCCH is scrambled with a second RNTI, the WTRU may use a second waveform type (e.g., a DFT-s-OFDM waveform) to transmit/receive one or more channels/signals.

For the FDRA, the WTRU may receive a waveform type indication based on indicated frequency resources. If the WTRU receives an indication of a first set of frequency resources, the WTRU may determine to use a first waveform type (e.g., a CP-OFDM waveform). If the WTRU receives an indication of a second set of frequency resources, the WTRU may determine to use a second waveform type (e.g., a DFT-s-OFDM waveform). The first and second set of frequency resources may be pre-defined, configured by an RRC, or signaled by a MAC CE.

For the TDRA, the WTRU may be configured with one or more sets of TDRA. One or more TDRAs (e.g., each TDRA) may include one or more of a slot offset, a start and length indicator (SLIV), a start symbol S, an allocation length L, channel mapping type, a number of repetitions, and a waveform type configuration. The WTRU may receive an indication of one or more TDRAs to transmit/receive one or more signals/channels. Based on the indicated one or more TDRAs, the WTRU may determine the associated waveform type to transmit/receive the one or more signals/channels. If a number of TDRAs is larger than 1, one (e.g., only one) of the indicated TDRAs may include a waveform type. If a number of TCI states is larger than 1 and multiple TDRAs indicate waveform types, the WTRU may apply one of the waveform types to transmit/receive the one or more signals/channels. In examples, the WTRU may apply the waveform type of a first TDRA (e.g., for single TRP). If a number of TCI states is larger than 1 and multiple TDRAs indicate waveform types, the WTRU may apply waveform types (e.g., each waveform type) of TDRAs (e.g., each TDRA) to transmit/receive the associated signal/channel with the TDRA. In examples, the WTRU may apply a first waveform type of a first TDRA to a first PDSCH/PUSCH and a second waveform type of a second TDRA to a second PDSCH/PUSCH (e.g., for multi-TRP).

For the MCS, the WTRU may receive a waveform type indication based on an indicated MCS. If the WTRU receives a MCS larger than a threshold, the WTRU may determine to use a first waveform type (e.g., a CP-OFDM waveform). If the WTRU receives a MCS smaller than (or equal to) the threshold, the WTRU may determine to use a second waveform type (e.g., a DFT-s-OFDM waveform). If a number of MCSs is larger than 1, the WTRU may determine a MCS based on one of the MCSs. In examples, the WTRU may use a first MCS to determine a waveform type. The WTRU may determine a MCS based on multiple MCSs. In examples, the WTRU may use an average value of multiple MCSs. The threshold may be predefined, configured with one or more of an RRC, a MAC CE, and DCI.

Examples of BWP level dynamic switching between different waveforms are provided herein. Waveform configuration/determinations for BWP may be included. One or more waveforms may be configured for a BWP. The one or more waveforms may include but are not limited to CP-OFDM, DFT-s-OFDM, clustered DFT-s-OFDM, Nx SC-FDMA, filtered OFDM, and so forth. A first waveform may be used, configured, or determined for a first BWP and a second waveform may be used, configured, or determined for a second BWP. If a WTRU receives one or more downlink channels and/or signals (e.g., PDCCH, PDSCH, SS/PBCH, reference signals) in a BWP, the WTRU may use the determined waveform for the BWP to receive the one or more downlink channels and/or signals within the BWP. One or more of following may apply: a type, a structure, a scheme of one or more downlink channels and/or signals that may be determined based on a waveform configured; or a WTRU may receive, monitor, or attempt to decode a first type of downlink channel and/or signal type associated with a first waveform in a BWP (e.g., association with, configured, or determined for the BWP).

For the type, structure, scheme of one or more downlink channels and/or signals that may be determined based on a waveform configured, a first PDCCH type may be associated with a first waveform and a second PDCCH type may be associated with a second waveform. An REG or CCE structure may be different based on its associated waveform. REG and/or CCE structure may be determined based on at least one of: the data RE locations, a reference signal location, REG to CCE mapping, or REG bundling. A first PDSCH type may be associated with a first waveform and a second PDSCH type may be associated with a second waveform. A DMRS structure may be different based on its associated waveform. The DMRS structure may be determined based on at least one of: DMRS time/frequency location within PDSCH resource, whether data REs and DM-RS REs are located within the same OFDM symbol or not, or the sequence type (e.g., Zadoff-Chu, m-sequence, gold sequence) used for the DMRS. A set of resource allocation types may be used or supported for a first waveform (e.g., a CP-OFDM waveform) and a subset of the resource allocation types may be used or supported for a second waveform (e.g., a DFT-s-OFDM waveform). A WTRU may determine a resource allocation type (e.g., contiguous allocation, RBG based allocation) based on the associated (or configured) waveform for the active BWP.

A waveform for a BWP may be determined (e.g., implicitly determined) based on one or more properties of the BWP. The one or more properties may include at least one of: subcarrier spacing, bandwidth, number of RBs, BWP identity, whether the BWP includes SSB, and whether the BWP include cell-defining SSB. A WTRU may determine a first waveform (e.g., a DFT-s-OFDM waveform) for a BWP if the bandwidth (or the number of RBs) for the BWP is larger than a threshold. The WTRU may determine (e.g., otherwise determine) a second waveform (e.g., a CP-OFDM waveform) for the BWP. If a BWP is larger than a threshold, a single-carrier based waveform (e.g., a DFT-s-OFDM waveform, a clustered DFT-s-OFDM waveform, a Nx SC-FDMA waveform) may be used in order to lower PAPR. Otherwise, a multi-carrier based waveform (e.g., a CP-OFDM waveform) may be used to increase spectral efficiency. A WTRU may determine a first waveform (e.g., a single-carrier based waveform) for an initial BWP (or default BWP) to reduce PAPR and support better coverage. The WTRU may determine a second waveform for other BWPs based on at least one of BWP properties and/or higher layer configuration.

Examples of BWP switching with different waveforms are provided herein. A WTRU may be indicated to switch a BWP from a first BWP (e.g., a serving BWP) to a second BWP (e.g., a target BWP) for a DL signal reception and/or a UL signal transmission. The first BWP and the second BWP may be associated with a same or different waveform. One or more of following may apply: a switching gap (e.g., BWP switching gap) length may be determined based on whether the waveforms are the same or not (e.g., a first switching gap may be used when the first and second BWP are associated with a same waveform and a second switching gap may be used when the first and second BWP are associated with a different waveform); DCI triggering BWP switching may include an associated waveform information for the target BWP (e.g., an explicit bit field in the DCI may indicate the waveform or a scheduling information may implicitly indicate the waveform. For example, if MCS level indicate for PDSCH scheduling in the target BWP is less than a threshold, a first waveform (e.g., single-carrier based waveform) may be used or determined for the BWP. Otherwise, a second waveform (e.g., multi-carrier based waveform) may be used or determined for the BWP); or a frequency domain resource allocation (FDRA) field in the DCI triggering BWP switching may be re-interpreted as a resource allocation type associated with the target BWP if the first waveform and the second waveform are different.

Examples of scheduling parameter set determinations based on a BWP are provided herein. A WTRU may be scheduled to receive one or more downlink channels and/or signals in a BWP and one or more scheduling parameter sets used in a BWP may be determined based on the associated waveform used for the BWP. A scheduling parameter set may include but is not limited to a MCS level, a modulation order, a minimum/maximum scheduling bandwidth, a DMRS density, a DMRS pattern, a frequency resource allocation type, a time resource allocation type, a number of repetitions, a slot aggregation number, a number of slots for TBMS configuration, and a slot length.

A first set of scheduling parameters may be used for a BWP with a first waveform (e.g., a single-carrier based waveform) and a second set of scheduling parameters may be used for a BWP with a second waveform (e.g., a multi-carrier based waveform). The first set of scheduling parameters may include a first subset of modulation order (e.g., BPSK, QPSK) and the second set scheduling parameters may include a second subset of modulation order (e.g., 16QAM, and 64QAM). The first set of scheduling parameters may include a first subset of resource allocation type (e.g., type-1) and the second set of scheduling parameters may include a second subset of resource allocation type (e.g., type-0 and type-1). The type-0 resource allocation may use resource block group (RBG) based resource allocation and the type-1 resource allocation may use contiguous resource allocation in the frequency domain. If a WTRU is in an active BWP associated with a first waveform, the WTRU may expect to receive a PDSCH with one of the modulation order (or MCS) within the subset associated the BWP (or waveform).

Examples of WTRU operations based on a determined waveform are provided herein. A WTRU may apply one or more of following operations to transmit/receive one or more signals and one or more of channels: different CORESET/search space structures, PDSCH reception, collision handling, PUSCH transmission, RS transmission, or a different SCS.

For the different CORESET/search space structures, the WTRU may assume different CORESET/search space structures for blind detection of PDCCHs. If the WTRU determines a first waveform (e.g., a CP-OFDM waveform), the WTRU may assume a resource element group (REG) in a symbol with frequency domain multiplexed (FDMed) control information and PDCCH DM-RS. If the WTRU determines a second waveform (e.g., a new waveform), the WTRU may assume an REG in two or more symbols with time domain multiplexed (TDMed) control information and a PDCCH DM-RS. The WTRU may assume parameters for CORESET/search space construction. If the WTRU determines a first waveform (e.g., a CP-OFDM waveform), the WTRU may assume a first parameter for CORESET/search space construction. If the WTRU determines a second waveform (e.g., a new waveform), the WTRU may assume a second parameter for CORESET/search space construction. The parameter may be one or more of the following: a number of REGs per CCE; a minimum and/or maximum durations of CORESET; or a number of REs per REG (e.g., 6 or 12). The WTRU may apply the determined waveform for control information of a PDCCH. If the WTRU detects a first waveform (e.g., a CP-OFDM waveform), the WTRU may (e.g., may blindly) detect PDCCH without application of an IDFT. If the WTRU detects a second waveform (e.g., a new waveform), the WTRU may apply an IDFT before PDCCH detection.

The WTRU may receive PDSCH transmission(s) in a second slot. For the PDSCH transmission(s) reception, the WTRU may receive a set of configurations for decoding PDSCH transmission(s). he WTRU may receive a set of configurations for a first waveform type associated with a first slot and a set of configurations for a second waveform type associated with a second slot. In examples, the first waveform type associated with the first slot may be a CP-OFDM waveform and the second waveform type associated with the second slot may be a DFT-s-OFDM waveform. In other examples, the first waveform type associated with the first slot may be a DFT-s-OFDM waveform and the second waveform type associated with the second slot may a CP-OFDM waveform. If the WTRU determines that the second waveform type associated with the second slot is a CP-OFDM waveform, the WTRU may apply the set of configurations associated with the second waveform type (e.g., a CP-OFDM waveform) for decoding the PDSCH transmission(s). The set of configurations for decoding the PDSCH transmission(s) (e.g., if the second waveform type is a CP-OFDM waveform) may include one or more of: a DMRS configuration (e.g., a DMRS pattern) associated with the CP-OFDM waveform, a PDSCH mapping type associated with the CP-OFDM waveform, a precoding resource block group (PRG) configuration associated with the CP-OFDM waveform, or a rate matching configuration associated with the CP-OFDM waveform. If the WTRU determines that the second waveform type associated with the second slot is a DFT-s-OFDM waveform, the WTRU may apply the set of configurations for decoding the PDSCH transmission(s). The set of configurations for decoding the PDSCH transmission(s) (e.g., if the second waveform type is a DFT-s-OFDM waveform) may include one or more of: a DMRS configuration (e.g., a DMRS pattern) associated with the DFT-s-OFDM waveform; a PDSCH mapping type associated with the DFT-s-OFDM waveform; a PRG configuration associated with the DFT-s-OFDM waveform; or a rate matching configuration associated with the DFT-s-OFDM waveform.

For a DMRS configuration (e.g., a DMRS pattern), if the WTRU determines that the second waveform type associated with the second slot is a CP-OFDM waveform, the WTRU may apply a set of DMRS configurations (e.g., DMRS patterns) associated with the CP-OFDM waveform. If the WTRU determines that the second waveform type associated with the second slot is a DFT-s-OFDM waveform, the WTRU may apply a set of DMRS configurations (e.g., DMRS patterns) associated with the DFT-s-OFDM waveform. If the WTRU determines that the second waveform type associated with the second slot is a CP-OFDM waveform, the WTRU may apply a DMRS type based on a gNB configuration. If the WTRU determines that the second waveform type associated with the second slot is a DFT-s-OFDM waveform, the WTRU may apply a fixed DMRS type (e.g., type-1 DMRS).

For the PRG configuration, if the WTRU determines the second waveform type associated with the second slot is a CP-OFDM waveform, the WTRU may apply a set of PRG configurations (e.g., candidates) associated with the CP-OFDM waveform. If the WTRU determines that the second waveform type associated with the second slot is a DFT-s-OFDM waveform, the WTRU may apply a set of PRG configurations (e.g., candidates) associated with the DFT-s-OFDM waveform. The WTRU may receive an indication of a PRG configuration of the determined set of PRG configurations (e.g., candidates) for PDSCH reception. In examples, if the WTRU determines that the second waveform type associated with the second slot is a CP-OFDM waveform, the WTRU may apply a PRG based on a gNB configuration (e.g., via an RRC) and/or an indication (e.g., via DCI). In examples, if the WTRU determines that the second waveform type associated with the second slot is a DFT-s-OFDM waveform, the WTRU may apply a fixed PRG (e.g., wideband).

For a rate matching configuration, if the WTRU determines that the second waveform type associated with the second slot is a CP-OFDM waveform, the WTRU may apply a set of rate matching configurations (e.g., resources) associated with the CP-OFDM waveform. If the WTRU determines that the second waveform type associated with the second set is a DFT-s-OFDM waveform, the WTRU may apply a set of rate matching configurations (e.g., resources) associated with the DFT-s-OFDM waveform. The WTRU may apply a different rate match pattern type based on the determined second waveform type. If the WTRU determines that the second waveform type associated with the second slot is a CP-OFDM waveform, the WTRU may receive a rate matching indication indicating bitmaps of a resource block (e.g., in a slot or two slots), periodicity/pattern, CORESET, and SCS. If the WTRU determines that the second waveform type is a DFT-s-OFDM waveform, the WTRU may receive a rate matching indication indicating one or more symbols for rate matching (e.g., in a slot or two slots), periodicity/pattern, CORESET, and SCS. The WTRU may apply the determined second waveform type for decoding the PDSCH transmission(s). If the determined second waveform type associated with the second slot is a CP-OFDM waveform, the WTRU may decode the PDSCH transmission(s) without application of an IDFT. If the determined second waveform type associated with the second slot is a DFT-s-OFDM waveform, the WTRU may apply an IDFT before decoding the PDSCH transmission(s).

For collision handling, the WTRU may determine a priority between dynamically scheduled PDSCHs and semi-statically configured PUSCHs. The WTRU may transmit/receive PDSCHs or PUSCHs with high priority and ignore PDSCHs or PUSCHs with low priority. The priority may be following: configured grant (semi-static) channels with a DFT-s-OFDM waveform>dynamic grant channels with a (DFT-s-OFDM waveform)>configured grant (semi-static) channels with a CP-OFDM waveform>dynamic grant channels with a CP-OFDM waveform.

For PUSCH transmission(s), the WTRU may receive a set of configurations for transmitting PUSCHs. The WTRU may receive a first set of configurations for a first waveform and a second set of configurations for a second waveform. If the WTRU determines the first waveform (e.g., the CP-OFDM waveform), the WTRU may apply the first set of configurations. If the WTRU determines the second waveform (e.g., the DFT-s-OFDM waveform), the WTRU may apply the second set of configurations. The configurations may include one or more of following configurations: a DMRS configuration, a PUSCH mapping type configuration, or a PRG configuration.

For the DMRS configuration, if the WTRU determines the first waveform (e.g., the CP-OFDM waveform), the WTRU may apply a first set of DMRS configurations. If the WTRU determines the second waveform (e.g., the DFT-s-OFDM waveform), the WTRU may apply a second set of DMRS configurations. If the WTRU determines the first waveform (e.g., the CP-OFDM waveform), the WTRU may apply a DMRS type based on a gNB configuration. If the WTRU determines the second waveform (e.g., the DFT-s-OFDM waveform), the WTRU may apply a fixed DMRS type (e.g., type-1 DMRS).

For the PRG configuration, if the WTRU determines the first waveform (e.g., the CP-OFDM waveform), the WTRU may apply a first set of PRG candidates. If the WTRU determines the second waveform (e.g., the DFT-s-OFDM waveform), the WTRU may apply a second set of PRG candidates. The WTRU may receive an indication of a PRG of the determined PRG candidates for a PUSCH transmission. If the WTRU determines the first waveform (e.g., the CP-OFDM waveform), the WTRU may apply a PRG based on a gNB configuration (e.g., via an RRC) and/or indication (e.g., via DCI). If the WTRU determines the second waveform (e.g., the DFT-s-OFDM waveform), the WTRU may apply a fixed PRG (e.g., wideband).

For the RS transmission, the WTRU may a set of configurations for transmitting/receiving rate matching RSs. The WTRU may apply a first set of configurations for a first waveform and a second set of configurations for a second waveform. If the WTRU determines the first waveform (e.g., the CP-OFDM waveform), the WTRU may apply the first set of configurations for transmitting/receiving rate matching RSs. If the WTRU determines the second waveform (e.g., the DFT-s-OFDM waveform), the WTRU may apply the second set of configurations associated with the second waveform type (e.g., the DFT-s-OFDM waveform) for transmitting/receiving rate matching RSs. The configurations may include one or more of following configurations: RS density, periodicity and offset, power control offset, QCL info, resource mapping, scrambling ID, CDM-type, density, time domain allocation, frequency band (wideband or partial band), frequency domain allocation, or number of ports. The WTRU may apply a different resource mapping pattern type based on the determined waveform. If the WTRU determines the first waveform (e.g., the CP-OFDM waveform), the WTRU may receive a resource mapping pattern indicating one or more bitmaps of a resource block or one or more of CDMs (e.g., in a slot). If the WTRU determines the second waveform (e.g., the DFT-s-OFDM waveform), the WTRU may receive a resource mapping pattern indicating one or more comb patterns (e.g., in a slot). If the WTRU determines the first waveform (e.g., the CP-OFDM waveform), the WTRU may apply a CDM type based on a gNB configuration (e.g., based on CDM-type). If the WTRU determines the second waveform (e.g., the DFT-s-OFDM waveform), the WTRU may apply a fixed DMRS type (e.g., no CDM).

For the different SCS, the WTRU may determine a SCS based on the determined waveform type. If the WTRU determines a first waveform (e.g., a CP-OFDM waveform), the WTRU may use a first SCS (e.g., 120 kHz) for its operation. If the WTRU determines a second waveform (e.g., a DFT-s-OFDM waveform), the WTRU may use a second SCS (e.g., 480 kHz or 960 kHz) for its operation.

Examples of the prioritization of waveforms for PDCCH decoding are provided herein. If operating in high frequencies, the WTRU may support multiple waveforms and slot level dynamic switching between different waveforms. As such, the WTRU may (e.g., may need to) prioritize the waveform receptions during the PDCCH decoding.

A WTRU may be configured with one or more waveforms for a slot, where the one or more waveforms may include but are not limited to DFT-s-OFDM, CP-OFDM, and so forth. In examples, a first waveform may be used, configured, or determined for a first slot and a second waveform may be used, configured, or determined for a second slot.

A WTRU may perform the reception procedure based on a first waveform with higher priority first (e.g., a CP-OFDM waveform). If decoding of the PDCCH is successful (e.g., based on the decoded CRC), the WTRU may continue with the reception procedure corresponding to the first waveform to demodulate the content of the respective slot (e.g., PDCCH, PDSCH, SS/PBCH block, reference signals). If the reception based on the first waveform is not successful (e.g., CRC is not valid), the WTRU may perform the reception procedure based on the second waveform (e.g., the DFT-S-OFDM waveform), and so forth.

There may be one or more actions during the reception procedure that may be the same for the different waveforms. If detection of the waveform with the first priority is successful, the WTRU may start the detection of the second waveform (e.g., while skipping the steps that are already accomplished on the received signal and during the process of detection of the first waveform). The WTRU may skip the actions that are similar with the ones for the first waveform and the WTRU may start with detection of the second waveform beginning from the actions that are different from the first waveform.

The WTRU may determine that the procedures corresponding to removing the Cyclic Prefix (CP), the DFT demodulation, and/or subcarrier de-mapping are the same for both DFT-S-OFDM and CP-OFDM waveforms. If the detection of the first waveform is based on the CP-OFDM and if it is unsuccessful, the WTRU may not go through the similar steps anymore and may pickup the process from the steps that are accomplished in the DFT-S-OFDM waveform different from the CP-OFDM waveform.

The prioritization of the waveforms may be determined based on one or more of the following: implicit indication, explicit indication, or WTRU capability and prioritization.

For the implicit indication, a WTRU may implicitly assume or determine the same prioritization as a SS/PBCH block received during the initial access. The WTRU may expect the waveform that was used in a SS/PBCH block transmission to be with the first prioritization. A WTRU may determine that the waveform configured for the previous slot can be considered as the waveform with the first prioritization. If configured with a waveform, the WTRU may consider that waveform as the first prioritization during the blind detection.

Explicit indication may be one or more of: pre-configuration, dynamic indication, or a system information block (SIB). For the pre-configuration, a WTRU may determine a (pre)configured/default prioritization for the waveform transmission. The WTRU may consider the preconfigured and/or default prioritization for the reception procedure (e.g., unless explicitly indicated). In examples, the WTRU may use a prioritized waveform type (e.g., an initial access waveform type or a default waveform) to receive PDCCH transmission(s) if a first slot is flexible. For dynamic indication, a WTRU may receive one or more activations (e.g., via a MAC CE) of semi-statically configured waveforms prioritization modes (e.g., via an RRC). Based on the prioritization, the WTRU may receive the one or more indications (e.g., via DCI) of the waveform prioritization modes. For the SIB, a WTRU may receive one or more indications of the waveform prioritization modes based on decoding one or more SIBs.

For WTRU capability and prioritization, a WTRU may determine the waveforms'prioritization based on a mode that was a priority defined by the WTRU and reported to NodeB. The WTRU may determine the waveforms' prioritization based on the WTRU capability, processing time, and so forth.

One or more processing times may be used, defined, configured, or determined, where processing times (e.g., each processing time) may be associated with a waveform's prioritization mode. A WTRU may be configured with a first processing time for the waveform with the first prioritization, and a second processing time for the waveform with the second prioritization, and so forth.

The processing times may be configured based on one or more of the following: the first processing time may be different from the second processing time (e.g., the second processing time may be longer than the first processing time); the processing times may be configured (e.g., configured exclusively) using higher layer parameters (e.g., RRC), through a MAC-CE, and/or through DCI; or the processing times may be configured based on the time difference relative to the first processing time or a reference processing time (e.g., using delta values). The reference processing time (e.g., Processing Time_ref) may be configured dynamically or semi-statically. The reference processing time may be the same as the processing time required for the waveform with the first prioritization. The differences in the processing times for waveforms with different priorities may be configured as delta values based on the reference processing time. For example, the delta processing time for the waveform with the first prioritization may be configured as ProcessingTime_Pr1=delta_1+ProcessingTime_ref, where delta_1 may be equal or more than zero.

Examples of CSI reporting for multiple waveforms are provided herein. In examples, a WTRU may be configured to derive a CSI report assuming that the PDSCH is transmitted using a certain waveform, and/or assuming that the PDSCH is transmitted (or not) using DFT precoding. Such an assumption may be referred to as a “waveform assumption.”

Determination of a waveform assumption may be explicit by an RRC, a MAC CE, or DCI. The WTRU may determine a waveform assumption applicable to a CSI report based on RRC signaling. In examples, a waveform assumption may be signaled as part of a CSI report configuration. The WTRU may determine the waveform assumption from a DCI field such as the aperiodic CSI trigger field (e.g., in case of an aperiodic CSI or semi-persistent CSI on a PUSCH) or from a MAC CE field (e.g., in case of a semi-persistent CSI on a PUCCH).

Determination of a waveform assumption may be implicit based on a CSI reference resource, a CSI-RS resource, a latest slot, or a current waveform. The WTRU may assume that the waveform is implicitly determined from at least one of the following: the waveform used for transmitting a PDSCH in a CSI reference resource; the waveform used for transmitting a CSI-RS resource used for deriving the CSI report; the waveform used in a downlink slot preceding (e.g., immediately preceding or N slots before) the slot (or subslot) in which the CSI report is transmitted; or the waveform indicated as current waveform from RRC or MAC CE signaling. The WTRU may determine the waveform used in a slot or for a transmission based on one of the examples described herein. In examples, the WTRU may determine the waveform in a CSI reference resource from a group DCI (slot format indication).

The CSI-RS waveform may be different from a CSI report waveform assumption. The WTRU may measure at least one CSI-RS transmission using a first waveform (e.g., a CP-OFDM waveform) and report CSI under the assumption of a second waveform (e.g., a DFTS-OFDM waveform). The WTRU may derive the CSI assuming that the PDSCH would be transmitted with a power offset compared to the transmission power of the CSI-RS. The power offset may depend on the first and second waveform. If the WTRU reports CSI with the assumption that a PDSCH is transmitted using a DFTS-OFDM waveform and measures a CSI-RS transmitted using a CP-OFDM waveform, the WTRU may assume that the PDSCH would be transmitted X dB higher than the CSI-RS. The power offset X may be dependent on the bandwidth of the applicable CSI quantity, including whether the CSI is reported for a subband or for the whole CSI report band (wideband granularity). The power offset X for a given bandwidth may be pre-defined, signaled by an RRC (e.g., as part of a CSI report confirmation), a MAC CE, or DCI.

The CSI report configuration may depend on a waveform assumption. A WTRU may apply first (or second) CSI report configuration parameters in case it reports a CSI for a first (or second) waveform assumption. The CSI report configuration parameters may include at least one of the following: a frequency granularity for CQI or PMI (e.g., between wideband or subband); a number of bits for subband CQI; a report quantity configuration such as CRI/RI/PMI/CQI or CRI/RI/CQI; a CSI reporting band configuration; a subband size; a CQI table; a codebook configuration including codebook subset restriction; or a power offset between CSI-RS and SSB or CSI-RS and PDSCH. At least one of the above parameters may be indicated by a MAC CE or DCI.

The WTRU may report a CSI with a wideband granularity if it determines that the waveform assumption is DFTS-OFDM. The WTRU may report CSI with a subband granularity if it determines that the waveform assumption is CP-OFDM. The WTRU may report CSI with a codebook subset restriction that includes (e.g., only includes) codebooks with rank 1 if it determines that the waveform assumption is DFTS-OFDM.

A CSI type may include a recommended waveform. The WTRU may derive a CSI for sets of possible waveform assumptions (e.g., each of a set of possible waveform assumptions) and report a recommended waveform and its associated CSI. The recommended waveform may be one that maximizes RI or (e.g., for the same RI) CQI if the CSI is derived from the waveform. If the CQI has subband granularity for a waveform, the maximum CQI among subbands may be utilized for comparison. The WTRU may derive (e.g., first derive) the CSI under an assumption that the waveform is CP-OFDM and determine the CQI with subband granularity. The WTRU may (e.g., may then) derive CSI under an assumption that the waveform is DFTS-OFDM and determine the CQI with wideband granularity. If the RI is equal, the WTRU may report DFTS-OFDM as the recommended waveform if the corresponding CQI is larger than the largest CQI for the CSI derived with a CP-OFDM waveform assumption. The WTRU may report CP-OFDM as the recommended waveform otherwise.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
receive slot format configuration information that indicates whether a first slot has a first waveform type associated with the first slot or is flexible and whether a second slot has a second waveform type associated with the second slot or is flexible;
receive a physical downlink control channel (PDCCH) transmission in the first slot, wherein the PDCCH transmission is received via a waveform of a prioritized waveform type based on the first slot being indicated in the slot format configuration information as flexible or via a waveform of the first waveform type based on the first waveform type being indicated in the slot format configuration information as being associated with the first slot, and wherein the PDCCH transmission comprises a downlink control information (DCI) that schedules a physical downlink shared channel (PDSCH) transmission and indicates an indicated waveform type associated with reception of the PDSCH transmission; and
receive the PDSCH transmission in the second slot, wherein the PDSCH transmission is received via a waveform of the indicated waveform type based on the second slot being flexible or via a waveform of the second waveform type based on the second waveform type being indicated in the slot format configuration information as being associated with the second slot.

17. The WTRU of claim 16, wherein:
the second waveform type is indicated in the slot format configuration information as being associated with the second slot, and
the waveform of the second waveform type associated with the second slot is indicated to be a discrete fourier transform-spread-orthogonal frequency domain multiplexing (DFT-s-OFDM) waveform.

18. The WTRU of claim 17, wherein the second slot carries at least one of: an initial access related signal, a configurable control resource set (CORESET)/synchronization signal (SS), or a reference signal for the DFT-s-OFDM waveform.

19. The WTRU of claim 17, wherein, based on the second waveform type being indicated in the slot format configuration information as being associated with the second slot and the waveform of the second waveform type associated with the second slot being indicated to be a DFT-s-OFDM waveform, the processor is further configured to apply an inverse discrete fourier transform (IDFT) before decoding the PDSCH transmission.

20. The WTRU of claim 16, wherein:
the second waveform type is indicated in the slot format configuration information as being associated with the second slot, and
the waveform of the second waveform type associated with the second slot is indicated to be a cyclic prefix-orthogonal frequency domain multiplexing (CP-OFDM) waveform.

21. The WTRU of claim 20, wherein the second slot carries at least one of: an initial access related signal, a CORESET/SS, or a reference signal for the CP-OFDM waveform.

22. The WTRU of claim 20, wherein, based on the second waveform type being indicated in the slot format configuration information as being associated with the second slot and the waveform of the second waveform type associated with the second slot being indicated to be a CP-OFDM waveform, the processor is further configured to decode the PDSCH transmission without applying an IDFT.

23. The WTRU of claim 16, wherein the waveform of the indicated waveform type for receiving the PDSCH transmission is one of the first waveform type or the second waveform type.

24. The WTRU of claim 16, wherein the waveform of the prioritized waveform type is an initial access waveform or a default waveform.

25. The WTRU of claim 16, wherein the slot format configuration information is received via one or more of: an RRC configuration, a MAC-CE, or a WTRU specific DCI.

26. A method implemented in a wireless transmit/receive unit (WTRU), comprising:
receiving slot format configuration information that indicates whether a first slot has a first waveform type associated with the first slot or is flexible and whether a second slot has a second waveform type associated with the second slot or is flexible;
receiving a physical downlink control channel (PDCCH) transmission in the first slot, wherein the PDCCH transmission is received via a waveform of a prioritized waveform type based on the first slot being indicated in the slot format configuration information as flexible or via a waveform of the first waveform type based on the first waveform type being indicated in the slot format configuration information as being associated with the first slot, and wherein the PDCCH transmission comprises a downlink control information (DCI) that schedules a physical downlink shared channel (PDSCH) transmission and indicates an indicated waveform type associated with reception of the PDSCH transmission; and
receiving the PDSCH transmission in the second slot, wherein the PDSCH transmission is received via a waveform of the indicated waveform type based on the second slot being flexible or via a waveform of the second waveform type based on the second waveform type being indicated in the slot format configuration information as being associated with the second slot.

27. The method of claim 26, wherein:
the second waveform type is indicated in the slot format configuration information as being associated with the second slot, and
the waveform of the second waveform type associated with the second slot is indicated to be a discrete fourier transform-spread-orthogonal frequency domain multiplexing (DFT-s-OFDM) waveform.

28. The method of claim 27, wherein the second slot carries at least one of: an initial access related signal, a configurable control resource set (CORESET)/synchronization signal (SS), or a reference signal for the DFT-s-OFDM waveform.

29. The method of claim 27, wherein, based on the second waveform type being indicated in the slot format configuration information as being associated with the second slot and the waveform of the second waveform type associated with the second slot being indicated to be a DFT-s-OFDM waveform, the method further comprises applying an inverse discrete fourier transform (IDFT) before decoding the PDSCH transmission.

30. The method of claim 26, wherein:
the second waveform type is indicated in the slot format configuration information as being associated with the second slot, and
the waveform of the second waveform type associated with the second slot is indicated to be a cyclic prefix-orthogonal frequency domain multiplexing (CP-OFDM) waveform.

31. The method of claim 30, wherein the second slot carries at least one of: an initial access related signal, a CORESET/SS, or a reference signal for the CP-OFDM waveform.

32. The method of claim 30, wherein, based on the second waveform type being indicated in the slot format configuration information as being associated with the second slot and the waveform of the second waveform type associated with the second slot being indicated to be a CP-OFDM waveform, the method further comprises decoding the PDSCH transmission without applying an IDFT.

33. The method of claim 26, wherein the waveform of the indicated waveform type for receiving the PDSCH transmission is one the first waveform type or the second waveform type.

34. The method of claim 26, wherein the waveform of the prioritized waveform type is an initial access waveform or a default waveform.

35. The method of claim 26, wherein the slot format configuration information is received via one or more of: an RRC configuration, a MAC-CE, or a WTRU specific DCI.
